(19) United States
(12) Patent Application Publication
(10) Pub. No.: US 2026/0214777 A1
(43) Pub. Date: Jul. 23, 2026

(54) Gesture Based Control for Controlling Lights of a Vehicle

(71) Applicant: AGCO International GmbH, Neuhausen (CH)

(72) Inventors: Adalbert Müller, Marktoberdorf (DE); Michael Kugelmann, Marktoberdorf (DE)

(21) Appl. No.: 19/141,031

(22) PCT Filed: Nov. 30, 2023
(86) PCT No.: PCT/IB2023/062061

§ 371 Date: Jun. 18, 2025

(30) Foreign Application Priority Data
Dec. 23, 2022 (GB) 2219640.6

(51) Int. Cl. H05B 47/175

(52) U.S. Cl. CPC H05B 47/1975

(57) ABSTRACT

A light control system for an agricultural vehicle has a light arrangement with at least two lights, a control unit, and a sensory input device with a sensor area for recognizing a gesture input. The sensor area has a first light control area assigned to one of the lights for controlling the one light and a second light control area assigned to the other light for controlling the other light. The control unit is configured to control the lights of the light arrangement independently from each other in response to a single gesture input. The light control system may be controlled by a method of controlling the lighting range of the at least two lights.

### FIELD

The present disclosure relates generally to a gesture based control for controlling lights of a vehicle.

### BACKGROUND

A vehicle such as a passenger car may comprise headlights, foglights and rear lights. These lights may be switched on or off by controlling a knob or a button. Other types of vehicles such as off-road vehicles like agricultural or construction vehicles may comprise additional lights as for example work lights for illuminating the surrounding of the off-road vehicle. These lights may be switched on or off. Additionally, the lighting range of the work lights may be controllable.

An illumination output of a light may be controlled by a touch controlled dimmer switch. An example of such a switch is disclosed in U.S. Pat. No. 4,246,494. A user may touch a pad of the switch at different locations to control the illumination output of the light.

### BRIEF SUMMARY

It is an objective to provide a gesture based control for controlling the lighting ranges of multiple (at least two) lights of a vehicle with a single gesture.

According to an aspect of the invention there is provided a light control system for an agricultural vehicle comprising a light arrangement with at least two lights, a control unit and a sensory input device with a sensor area for recognizing a gesture input. The sensor area comprises a first light control area assigned to one of the lights for controlling the one light and a second light control area assigned to the other light for controlling the other light. The control unit may be configured to control the lights of the light arrangement independently from each other in response to a single gesture input.

The light arrangement may comprise different types of lights such as headlights, foglights, full beam, rear lights, reversing lights, warning lights, spot lights or work lights. The lights may be attached to the vehicle at different locations as for example a roof of the vehicle, a part of the body of the vehicle, a frame or a pillar of a cabin of the vehicle. The sensory input device may be located close to other manual operator controls of the vehicle, for example close to a steering wheel. An operator may control the lights by performing a gesture within the sensor area of the sensory input device. The gesture may be performed in the first light control area or in the second light control area. If a gesture input is recognized in the first light control area one of both lights is controlled. Analogously, if a gesture input is recognized in the second light control area the other light is controlled. Additionally, the gesture may be performed in both light control areas so that the operator may control the one and the other light independently from each other by a single gesture input. I. e., the operator may control multiple lights of the light arrangement without the need of performing a separate gesture for each light. In addition, each light may be controlled independently from each other so that the single gesture input may be used for switching the one and the other light individually as for example switching both lights on or off as well as switching one light on and the other light off.

The sensor area may be configured to recognize any gesture of the operator. For example, the gesture may be a hand gesture. The sensor area may comprise a capacitive sensor to recognize a contactless gesture input. The sensory input device may also comprise alternative devices such as a camera to detect a gesture input.

Optionally, the sensor area may be a touch sensitive area for recognizing touch gestures.

The control unit may be configured to set a lighting range of each light independently from any other light in response to a single gesture input.

The lighting range may be set to a level greater than a minimum lighting range and smaller than a maximum lighting range. The maximum lighting range of a light determines the distance how far the corresponding light can illuminate its environment. The maximum lighting range of each light of the light arrangement may depend on technical properties such as the lighting power or the lens geometry of the corresponding light and may vary from one light to another light. For example, the maximum lighting range of the one light may be 200 meters and the maximum lighting range of the other light may be 225 meters.

The single gesture input may not only be used for switching the lights on or off but also for setting the lighting range of each light to any interim level between the minimum and the maximum lighting range of the corresponding light. The interim level may be set for each light individually by the same gesture input. For example, the single gesture input may be used to set the lighting range of the one light to 30% of the maximum lighting range and to set the lighting range of the other light to 75% of the maximum lighting range.

The sensory input device may comprise a first indicator to indicate a maximum lighting range for each of the at least two lights. The control unit may be configured to determine the maximum lighting range for each of the at least two lights and to control the first indicator to indicate the maximum lighting range for each of the at least two lights.

The first indicator may be an optical visible indicator being adjustable according to the different maximum lighting ranges of the at least two lights. The first indicator may comprise a light bar to indicate different lighting ranges by different bar heights of the light bar. Based on the first indicator, the operator may check the distribution of the lighting ranges of the at least two lights.

The first indicator may be integrated at least partly in the first light control area for indicating the maximum lighting range of the one light and in the second light control area for indicating the maximum lighting range of the other light.

Thus, the sensor area of the sensory input device may be used for controlling the lighting ranges of the lights as well as for indicating the lighting ranges of the corresponding lights.

The first indicator may be illuminable.

For example, the light control areas of the corresponding lights may be individually illuminated by the first indicator comprising light elements integrated in the sensory input device such as for example LEDs or a display. The sensor area may have an at least partly transparent surface for illuminating the first and second light control areas. The size of the illuminated areas of the first and second light control area may correspond to the maximum lighting range of the light assigned to the corresponding light control area.

The first light control area and the second light control area may comprise each a first lighting range control area, a second lighting range control area and a third lighting range control area for controlling the lighting range of the one and the other light.

I. e., a first, a second and a third lighting range control area are assigned to the one light as well as another first, another second and another third lighting range control area are assigned to the other light. Hence, a single gesture input may be recognized in at least one of the three lighting range control areas of the first light control area of the one light and in at least one of the three lighting range control areas of the second light control area of the other light. The lighting range of each light may depend on the lighting range control area in which the gesture input has been recognized. For example, the single gesture input may be recognized in the second lighting range control area of the first light control area to set the lighting range of the one light to a level assigned to the second lighting range control area and the single gesture input may also be recognized in the third lighting range control area of the second light control area to set the lighting range of the other light to a level assigned to the third lighting range control area wherein the lighting range assigned to the second lighting range control area and the lighting range assigned to the third lighting range control area may be different. Thus, the lighting range of the one and the other light may be controlled individually by a single gesture input in dependence of the lighting range control area of the corresponding light in which a gesture input could be recognized.

The control unit may be configured to adjust the size of the second lighting range control area of the first light control area according to the maximum lighting range of the one light and to adjust the size of the second lighting range control area of the second light control area according to the maximum lighting range of the other light.

The control unit may determine an overall maximum lighting range of all lights of the light arrangement and set the maximum lighting range of each light in relation to the overall maximum lighting range. For example, the overall maximum lighting range may be 300 meters. Thus, the maximum lighting range of the light providing the maximum overall lighting range may correspond to a percentage value of 100%. Then, the maximum lighting range of the one light providing exemplarily 200 meters may correspond to a percentage value of 67% and the maximum lighting range of the other light providing exemplarily 225 meter may correspond to a percentage value of 75%. Consequently, the size of the second lighting range control area of the first light control area may be reduced to a size corresponding to 67% and the size of the second lighting range control area of the second light control area may be reduced to a size corresponding to 75%.

The control unit may be configured to adjust the size of the third lighting range control area of the first light control area according to the maximum lighting range of the one light and to adjust the size of the third lighting range control area of the second light control area according to the maximum lighting range of the other light.

Thus, the third lighting range control areas of the first and the second light control area may be increased according to the reduction of the size of the second lighting range control area of the first light control area and the size of the second lighting range control area of the second light control area so that the third lighting range control areas adjoin the second lighting range control areas.

The first indicator may illuminate the areas of each second lighting range control area. Since the size of each second lighting range control area assigned to a light may have been adjusted to the maximum lighting range of the corresponding light the illuminated area of each second lighting range control area may correspond to the maximum lighting range of the light assigned to the corresponding second lighting range control area. Thus, the sensory input device may provide an optically visible comparison of the maximum lighting ranges of each light of the light arrangement.

The control unit may be configured to set a lighting range of a light of the light arrangement to maximum lighting range if a gesture input recognized in the light control area of the assigned light is located in the third lighting range control area of the light control area of the assigned light only.

A light may be switched off if a gesture input recognized in the light control area of the assigned light is located in the first lighting range control area of the light control area of the assigned light only and may be switched on if a gesture input recognized in the light control area of the assigned light is located in the second or third lighting range control area of the light control area of the assigned light. If a gesture input recognized in the light control area of the assigned light is not located only in one of the first or the third lighting range control area of the light control area of the assigned light but in more than one of the lighting range control areas of the light control area of the corresponding light the lighting range may be set to the highest level according to the corresponding lighting range control area for example. Nevertheless, a single gesture input may be recognized in more than one light control area located in different lighting range control areas of the separate light control areas to control the lighting range of the corresponding lights individually.

The control unit may be configured to determine whether the gesture input was started in a first, a second or a third lighting range control area.

I. e., the control unit may distinguish in which of the three lighting range control areas a gesture input has been initiated by an operator independently from the light control area the lighting range control area is part of. For example, the control unit may determine that a gesture input was started in a second lighting range control area which may be part of the first or second light control area.

The control unit may be configured to determine in which of the first lighting range control areas, second lighting range control areas or third lighting range control areas the gesture input was started.

I. e., control unit may exactly determine in which lighting range control area of which light control area a gesture input of an operator has been initiated. For example, the control unit may determine that a gesture input was started in the second lighting range control area of the first light control area.

The control unit may be configured to determine a demanded lighting range of a light according to a gesture input recognized in the second lighting range control area of the assigned light and to set the lighting range of the light according to the demanded lighting range of the light.

Since the first lighting range control area assigned to a light may be used to switch off the light and the third lighting range control area assigned to the light may be used to set the lighting range of the light to a maximum level, the second lighting range control area assigned to the light may be used to set the lighting range of the light to any interim level between a minimum and the maximum lighting range of the corresponding light. The control unit may determine a demanded lighting range based on the gesture input in the second lighting range control area and set the interim level in response to the demanded lighting range. For example, the control unit may set the lighting range of a light having a maximum lighting range of 67% of the overall maximum lighting range up to 67% of the overall maximum lighting range and may set the lighting range of another light having a maximum lighting range of 75% of the overall maximum lighting range up to 75% of the overall maximum lighting range. The interim level may be adjusted stepwise by raising or lowering the level according to a predefined step as for example 10%. Alternatively, the interim level may be adjusted continuously between 0 and 100% according to the demanded lighting range. Then, the control unit may set the lighting range of the light according to the interim level. Thus, the light may be dimmed between the minimum and the maximum lighting range of the light according to the determined interim level.

At least one of the lights of the light arrangement may be a matrix light having two or more light elements. The second lighting range control area of the assigned matrix light may comprise a separate switch field for each light element of the matrix light.

The two or more light elements of the matrix light may be individually controllable. For example, the matrix light may have 16 light elements arranged in a 4×4 matrix. The second lighting range control area assigned to the matrix light may have a number of switch fields corresponding to the number of light elements of the matrix light. The switch fields may be arranged in a matrix corresponding to the matrix of the matrix light for a very intuitive control of the light elements of the matrix light. So, in case of a 4×4 matrix light the second lighting range control area assigned to the matrix light may comprise 16 switch fields arranged in a 4×4 matrix.

The light arrangement may comprises a non-dimmable light being switchable in an off state if the demanded lighting range is below a switching threshold and being switchable in an on state if the demanded lighting range is above the switching threshold.

Hence, all lights of the light arrangement may be controlled by the light control system irrespectively whether one or more of the lights of the light arrangement are dimmable or not. The switching threshold may be defined at 50% of the maximum lighting range of the corresponding non-dimmable light. If the demanded lighting range of the non-dimmable light is below the switching threshold the non-dimmable light may be switched off. Otherwise, if the demanded lighting range exceeds the switching threshold the non-dimmable light may be switched on.

The control unit may be configured to determine a demanded lighting range of a light according to a maximum displacement of the gesture input in the second lighting range control area of the assigned light started from the first or the third lighting range control area.

When an operator performs a gesture within the sensor area the operator may start the gesture in the first or the third lighting range control area of a light and continue the gesture in the second lighting range control area of the light. For example, the operator may move a finger from the first lighting range control area to the second lighting range control area. Then, the control unit may determine a distance from the edge of the first lighting range control area to a point of the gesture performed in the second lighting range control area being most distanced from the first lighting range control area as the maximum displacement of the gesture input in the second lighting range control area. Analogously, if the gesture input started in the third lighting range control area the maximum displacement may be determined based on a point of the gesture performed in the second lighting range control area being most distanced from the third lighting range control area. Since there may be only one point being most distanced from the first or the third lighting range control area the control unit can determine an unambiguous demanded lighting range based on that point.

The control unit may be configured to determine a demanded lighting range of a light according to a median of a displacement of the gesture input in the second lighting range control area of the assigned light if a starting point of the gesture input was detected in the second lighting range control area.

A gesture may be performed in a second lighting range control area without starting from the first or the third lighting range control area. Then, the control unit may not have a clear indication whether a maximum displacement of the gesture input shall be determined from the first or the third lighting range control area. Hence, the control unit may determine a median of the displacement of the gesture input in the second lighting range control area since the median can be determined without any information about from which of the first or third lighting range control area the gesture input started.

The sensory input device may comprise a second indicator to indicate a current lighting range for each of the one and the other light. The control unit may be configured to determine a lighting range of the one light and a lighting range of the other light and to control the second indicator to indicate the lighting range of the one light and the lighting range of the other light.

The second indicator may be integrated at least partly in the first light control area for indicating the lighting range of the first light and in the second light control area for indicating the lighting range of the second light. Hence, the current lighting range of a light may be indicated analogously to the maximum lighting range of the light by illuminating the light control area assigned to the light. The second indicator may be an optical visible indicator being adjustable according to different levels of the lighting range. Based on the second indicator, the operator may check whether the lighting ranges of the first and second lights are set correctly.

Analogously to the first indicator, the second indicator may comprise LEDs or a display for emitting light of a first color, e. g. white, for indicating the maximum lighting range of the light and for emitting light of a second color, e. g. orange, for indicating the current lighting range of that light. Thus, an operator can easily differentiate between the first and the second indicator.

The size of the illuminated area of the second lighting range control area illuminated by the second indicator may correspond to the current lighting range of the light assigned to the second lighting range control area. For example, if a lighting range of a light having a maximum lighting range of 80% of the overall maximum lighting range is set to a lighting range corresponding to 50% of the overall maximum lighting range, the illuminated area of the second lighting range control area of that light corresponds to an area for indicating a lighting range of 62,5%(=⅝) of the maximum lighting range of that light.

Thus, the sensor area of the sensory input device may be used for controlling the lighting ranges of the lights, for indicating the maximum lighting range of the corresponding lights as well as for indicating the lighting range of the corresponding lights. Consequently, a very intuitive control of the light arrangement may be achieved.

The first, the second and the third lighting range control areas may be arranged in circular shapes.

In such an arrangement, the lighting range control areas of each light can be similarly arranged as the lights in the light arrangement of the vehicle so that the orientation of the lighting range control areas of each light control area assigned to a light may correspond to the direction into which each light of the light arrangement is oriented to. For example, the first to third lighting range control areas assigned to a light located at a front side of the vehicle may be arranged at a top part of the sensor area, the first to third lighting range control areas assigned to a light located at a right side of the vehicle may be arranged at a right part of the sensor area, the first to third lighting range control areas assigned to a light located at a rear side of the vehicle may be arranged at a bottom part of the sensor area and the first to third lighting range control areas assigned to a light located at a left side of the vehicle may be arranged at a left part of the sensor area. The orientation of each light may be stored in a memory of the control unit so that the control unit may adjust the orientation of the lighting range control areas accordingly. Thus, a very intuitive control of the light arrangement may be achieved. Alternatively, the lighting range control areas may be arranged in rectangular shapes.

In addition, the control unit may adjust the size of each light control area according to a beam angle of a light assigned to the light control area. For example, the angle of a circular shaped light control area assigned to a light may correspond to the beam angle of the light assigned to the light control area. Alternatively, a width of a rectangular shaped light control area assigned to a light may correspond to the beam angle of the light assigned to the light control area. The beam angles of the lights of the light arrangement may be stored in the memory of the control unit. Thus, the operator gets a very representative impression how the lights of the light arrangement illuminate the environment around the vehicle.

The first lighting range control areas may be arranged in most inner circular shapes and the third lighting range control areas may be arranged in most outer circular shapes.

In such an arrangement, the second lighting range control areas may be arranged in the middle of the sensor area. Then, the lighting range of a light may be increased by a gesture input starting from the middle of the sensor area and being performed outwardly in direction to the third lighting range control area. The outward directed gesture input may be associated with a light emitting out more light. Further, the lighting range of a light may be decreased by a gesture input starting from the third lighting range control area of the sensor area and being performed inwardly in direction to the middle of the sensor area. The inward directed gesture input may be associated with a light emitting out less light. Thus, a very intuitive control of the light arrangement may be achieved.

The sensory input device may comprise at least one key. The control unit may be configured to determine a lighting range of the first light and a lighting range of the second light and to assign at least one of the lighting ranges of the first and second light to the key.

The key may be programmable so that the control unit may save a current lighting setting to the memory and assign the lighting setting to the key. The key may be used by an operator as a short-key for restoring the previously saved lighting setting and to set the lighting range of each light as saved.

The control unit may be configured to determine a number of lights of the light arrangement and to assign each light to a different light control area.

The control unit may also be configured to adjust a number of light control areas of the sensor area according to the number of lights of the light arrangement.

Thus, the light control system may automatically configure itself and may automatically be adapted if the number of the lights of the light arrangement is changed. The light control system may also automatically reconfigure itself if the orientation of a light is changed or if a beam angle of a light is changed so that the changed orientations or beam angles are represented by an updated orientation or updated size of the light control areas.

The control unit may be configured to swap a lighting setting of the lights at a right side of the light arrangement with a lighting setting of the lights at a left side of the light arrangement.

For example, the control unit may swap the settings if the vehicle changes the driving direction from one direction (e. g. direction to the north) to an opposite direction (e. g. direction to the south). Thus, a glaring of any persons or drivers may be avoided automatically when the vehicle passes the persons or drivers from one direction or from the other direction.

Another aspect includes a method of controlling the lighting ranges of at least two lights of a light arrangement by a sensory input device comprising a first light control area with a first, a second and a third lighting range control area assigned to one of the at least two lights and a second light control area with a first, a second and a third lighting range control area assigned to the other of the at least two lights, the method comprising the steps of recognizing a gesture input in the second lighting range control area assigned to the one light and recognizing a gesture input in the second lighting range control area assigned to the other light, determining a demanded lighting range for each of the at least two lights according to a maximum displacement of the gesture input in each of the second lighting range control areas assigned to the at least two lights started from a first or a third lighting range control area or determining a demanded lighting range for each of the at least two lights according to a median of a displacement of the gesture input in each of the second lighting range control area assigned to the at least two lights if a starting point of the gesture input was detected in one of the second lighting range control areas.

The method may be carried out by the control unit to control the lights of the light arrangement independently from each other in response to a single gesture input. The method may recognize if a single gesture input of an operator is performed in both light control areas. The method may determine a demanded lighting range for each light separately based on the single gesture input performed in the different light control areas. Then, each light may be controlled independently from each other according to the demanded lighting ranges by the control unit so that the one and the other light may be switched individually as for example setting the lighting range of one light to a first level and setting the lighting range of the other light to a second level being different to the first level. I. e., the operator may control multiple lights of the light arrangement without the need of performing a separate gesture for each light.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates an agricultural vehicle with a light arrangement from a first perspective.

FIG. 2 illustrates the agricultural vehicle of FIG. 1 from a second perspective.

FIG. 3 illustrates a schematic view of a control unit.

FIG. 4A illustrates a sensory input device for controlling lights of the light arrangement.

FIG. 4B illustrates a sensory input device for controlling lights of the light arrangement.

FIG. 5 illustrates a sensory input device for controlling lights of the light arrangement.

FIG. 6A illustrates a sensory input device for controlling lights of the light arrangement.

FIG. 6B illustrates a sensory input device for controlling lights of the light arrangement.

FIG. 7A illustrates a sensory input device for controlling lights of the light arrangement.

FIG. 7B illustrates a sensory input device for controlling lights of the light arrangement.

FIG. 8A illustrates a sensory input device for controlling lights of the light arrangement.

FIG. 8B illustrates a sensory input device for controlling lights of the light arrangement.

FIG. 9A illustrates a sensory input device for controlling lights of the light arrangement.

FIG. 9B illustrates a sensory input device for controlling lights of the light arrangement.

FIG. 10A illustrates a sensory input device for controlling lights of the light arrangement.

FIG. 10B illustrates a sensory input device for controlling lights of the light arrangement.

FIG. 11A illustrates a sensory input device for controlling lights of the light arrangement.

FIG. 11B illustrates a sensory input device for controlling lights of the light arrangement.

FIG. 12A illustrates a sensory input device for controlling lights of the light arrangement.

FIG. 12B illustrates a sensory input device for controlling lights of the light arrangement.

FIG. 12C illustrates a sensory input device for controlling lights of the light arrangement.

FIG. 13A illustrates a sensory input device for controlling lights of the light arrangement.

FIG. 13B illustrates a sensory input device for controlling lights of the light arrangement.

FIG. 14 illustrates a flow chart.

### DETAILED DESCRIPTION

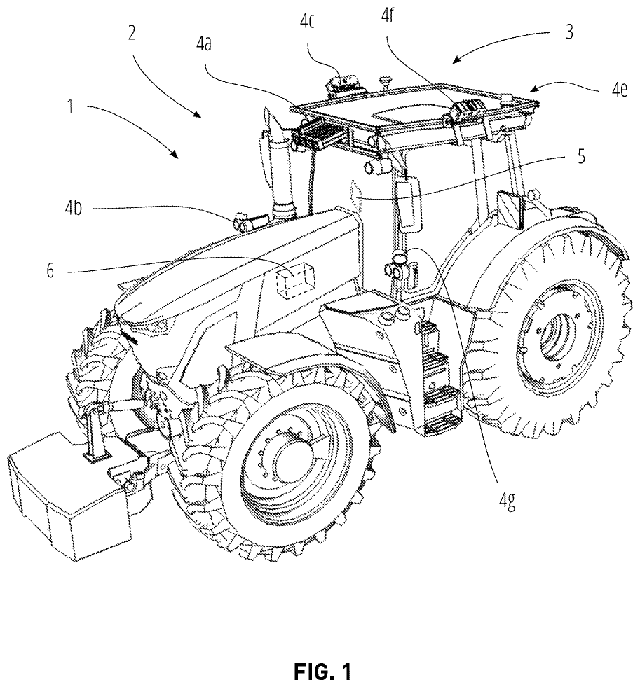

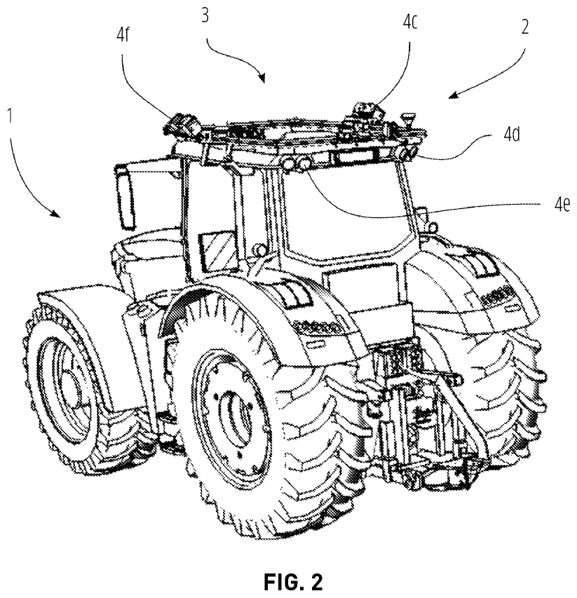

FIG. 1 and FIG. 2 show an agricultural vehicle 1 comprising a light control system 2 with a light arrangement 3, a control unit 6 and a sensory input device 5. The light arrangement 3 comprises several lights 4a to 4g. Lights 4a, 4c, 4d, 4e and 4f are attached to a roof of the vehicle 1. Lights 4b and 4g are attached to a pillar of a cabin of the vehicle 1. The light arrangement 3 may comprise additional lights. The lights 4a to 4g are designed as work lights. Alternatively, some of the lights 4a to 4g or some of the additional lights may be a headlight, a foglight, a full beam, a rear light, a reversing light, a warning light or a spot light. The lights 4a to 4g may be of any type such as a conventional light, a halogen light or a LED. The lights 4a to 4g may be dimmable lights. At least one of the lights 4a to 4g may be a matrix light with individually controllable light elements arranged in a matrix as for example a 4×4 matrix.

The lights 4a to 4g have different maximum lighting ranges. The maximum lighting range of a light determines the distance how far the corresponding light can illuminate its environment. The maximum lighting range of each light of the light arrangement may depend on technical properties such as the lighting power or the lens geometry of the corresponding light and may vary from one light to another light. For example, the maximum lighting range of light 4 a may be 200 meters, the maximum lighting ranges of the lights 4b, 4d, 4e and 4g may be 225 meters and the maximum lighting ranges of the lights 4c and 4f may be 300 meters. Thus, an overall maximum lighting range of the light arrangement 3 is based on the maximum lighting range of 300 meters of the lights 4c and 4f.

The control unit 6 is configured to determine the maximum lighting range of each light 4a to 4g of the light arrangement 3. For example, properties of the respective lights such as illumination power or data of the lens geometry may be stored in a memory 8 of the control unit 6 for determining the maximum lighting range of each individual light 4a to 4g. Optionally, the maximum lighting range of each light 4a to 4g may be stored as a parameter in the memory 8 and the control unit 6 may read out the parameter to determine the maximum lighting range of each light 4a to 4g. Additionally, the control unit 6 determines the overall maximum lighting range of the light arrangement 3 based on the lighting range of the light providing the greatest maximum lighting range.

The current lighting ranges of the lights 4a to 4g may be adjusted by the control unit 6 between a minimum lighting range and the maximum lighting range of the corresponding light. For example, lighting range of light 4c may be 300 meters if light 4c operates with full power but may be adjusted to 200 meters if the light 4c is dimmed accordingly.

The sensory input device 5 is a human machine interface (HMI) and is integrated in the cabin of the vehicle 1. The sensory input device 5 is close to other control elements such as a steering wheel for a direct access by an operator of the vehicle. The sensory input device 5 can be used by an operator to control the lighting range of each light 4a to 4g of the light arrangement 3 individually.

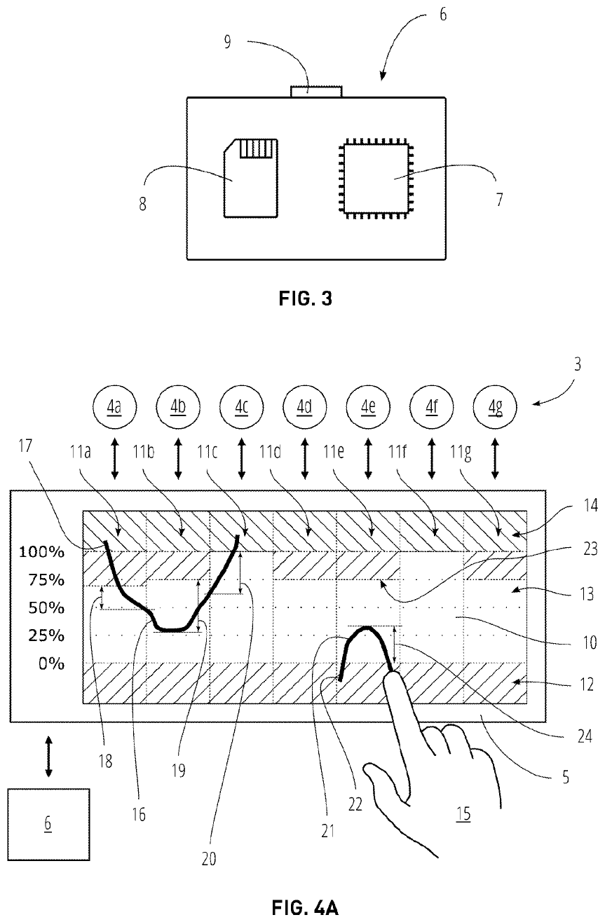

FIG. 3 shows the control unit 6 comprising an interface 9, a controller 7 and the memory 8. The control unit 6 is connected with the light arrangement 3 and the sensory input device 5 for exchanging signals between these devices and for processing of the signals. The control unit 6 may receive and send signals or data via the interface 9. The interface 9 may be a wireless interface or a connector. The controller 7 may store the data or signals received by the control unit 6 in the memory 8. The memory 8 may contain additional data or executable computer program products, for example in terms of a computer-implemented method, that may be retrieved, processed or executed by the controller 7. Data or signals resulting from the processing of data or signals or from the execution of a computer program product may be stored to the memory 8 or sent to the interface 9 by the controller 7.

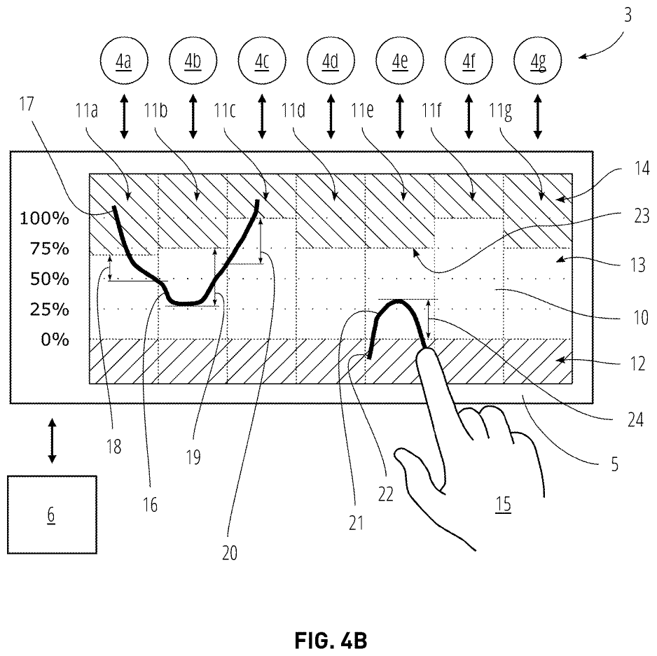

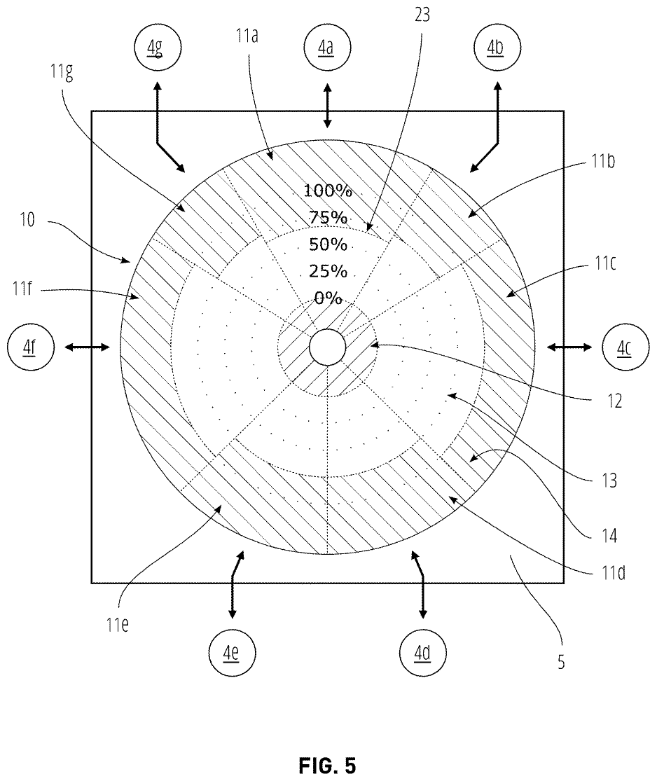

FIG. 4A, FIG. 4B and FIG. 5 show the sensory input device 5 having a sensor area 10. The sensory input device 5 may have a rectangular shape as shown in FIG. 4A and FIG. 4B or alternatively may have a different shape as for example a circular shape as exemplarily shown in FIG. 5. The sensor area 10 is configured to recognize a gesture input, such as gesture inputs 16 or 21, and is designed as a touch sensitive area for recognizing touch gestures performed by a hand 15 or a finger of an operator. Optionally, the sensor area 10 may comprise a capacitive sensor to recognize a contactless gesture input.

The sensor area 10 comprises several light control areas 11a to 11g. Each light control area 11a to 11g is assigned to a corresponding light 4a to 4g. For example, a first light control area 11a is assigned to light 4a, a second light control area 11b is assigned to light 4b and a third light control area 11c is assigned to light 4c, etc. so that a light can be controlled according to a gesture input (16, 21) performed in its assigned light control area.

The sensor area 10 is divided into a first, a second and a third lighting range control area 12, 13 and 14 overlapping the light control areas 11a to 11g. Hence, each light control area 11a to 11g comprises a first, a second and a third lighting range control area 12, 13 and 14 so that a lighting range of a light can be controlled according to a gesture input (16, 21) performed in a lighting range control area of its assigned light control area. The first, second and third lighting range control areas 12, 13 and 14 may be arranged in rectangular shapes in case of a rectangular sensor area 10 as shown in FIG. 4A or may be arranged in circular shapes in case of a circular sensor area 10 as shown in FIG. 5. If the first, second and third lighting range control areas 12, 13 and 14 are arranged in circular shapes then the first lighting range control areas 12 may be arranged in radially most inner circular shapes and the third lighting range control areas 14 may be arranged in radially most outer circular shapes.

The second lighting range control areas 13 of the light control areas 11a to 11g may be used to set the lighting range of each light 4a to 4g to a specific percentage value of the overall maximum lighting range of the light arrangement 3. The size of the second lighting range control area 13 of each light control area is individually adjustable for each light 4a to 4g according to its maximum lighting range as exemplarily shown in FIG. 4A, FIG. 4B and FIG. 5. The control unit 6 may calibrate the second lighting range control areas 13 in respect of the overall maximum lighting range and the individual maximum lighting range of each light 4a to 4g. For example, the overall maximum lighting range of 300 meters corresponds to a percentage value of 100%. Hence, the second lighting range control areas 13 assigned to the lights 4c and 4f each having a maximum lighting range of 300 meters corresponds also to a percentage value of 100%. But the second lighting range control areas 13 assigned to lights 4b, 4d, 4e and 4g each having a maximum lighting range of 225 meters may correspond to a percentage value of 75% and the second lighting range control area 13 assigned to light 4a having a maximum lighting range of 200 meters may correspond to a percentage value of 67%.

The first lighting range control areas 12 of the light control areas 11a to 11g cover an area of the sensor area 10 below a percentage value of 0% of the overall maximum lighting range. Thus, each first lighting range control area 12 adjoins a second light second lighting range control area 13. The third lighting range control areas 14 of the light control areas 11a to 11g cover an area of the sensor area 10 above a percentage value of 100% of the overall maximum lighting range.

As can be seen in FIG. 4A, only the second lighting range control areas 13 of the light control areas 4c and 4f adjoin the third lighting range control areas 14 of the light control areas 4c and 4f since the maximum lighting range of the lights 4c and 4f only corresponds to the overall maximum lighting range of the light arrangement 3.

Optionally, as can be exemplarily seen in FIG. 4B and FIG. 5, the third lighting range control areas 14 of the light control areas 11a to 11g may be adapted in respect of the maximum lighting range of each light 4a to 4g so that the second and the third lighting range control area 13 and 14 of each light control area 11a to 11g adjoin each other. Thus, several third lighting range control areas 14 may cover an area of the sensor area 10 below a percentage value of 100% of the overall maximum lighting range as for example the third lighting range control areas 14 of the light control areas 11a, 11b, 11d, 11e and 11g. Thus, a border between the second and the third lighting range control area 13 and 14 is adapted accordingly for each first light control area 11a to 11g.

If the overall maximum lighting range of the light arrangement 3 changes due to a failure of a light having influence of the overall maximum lighting range or due to an installation of a new light in the light arrangement 3 resulting in an increase of the overall maximum lighting range the control unit 6 can recalibrate the second and the third lighting range control areas 13 and 14 in respect of the changed overall maximum lighting range.

Size and orientation of the light control areas 11a to 11g may depend on additional properties of the lights 4a to 4g. As can exemplarily be seen in FIG. 5, the orientation of the light control areas 11a to 11g may correspond to the direction into which each light 4a to 4g of the light arrangement 3 is oriented to. For example, as can be seen in FIG. 1, light 4a is oriented to a front side, light 4c is oriented to a right side and light 4f is oriented to a left side. Correspondingly, the light control area 11a assigned to light 4a is oriented to a top of the sensory input device 5, light control area 11c assigned to light 4c is oriented to a right side of the sensory input device 5 and light control area 11f assigned to light 4f is oriented to a left side of the sensory input device 5. The other light control areas 11b, 11d, 11e and 11g are oriented analogously. The information about the orientation of the lights 4a to 4g may be stored in the memory 8 of control unit 6.

The lights 4a to 4g may have different beam angles. The beam angle of each light 4a to 4g may be stored in the memory 8 of the control unit 6 so that the control unit 6 may adapt the size of each light control area 11a to 11g according to the beam angle of the corresponding light. Then, the control unit 6 may adjust the size of each light control area 11a to 11g according to the light beam of the light assigned to the corresponding light control area. In case of the circular sensor area 10 as shown in FIG. 5, the control unit 6 may adapt the size of a light control area 11a to 11g by adjusting an angle of the circular shape representing the light control area according to the beam angle of the light assigned to the light control area. Thus, as can be seen in FIG. 5, the angles of the circular shapes of the light control areas 4a to 4g represent the beam angles of the corresponding lights 4a to 4g. For example: The beam angle of light 4b may be smaller than the beam angle of light 4c resulting in a light control area 11b having a circular shape with a smaller angle than the angle of the circular shape of the light control area 11c. Analogously, the rectangular shapes of the light control areas 11a to 11g of the sensory input device 5 as shown in FIG. 4A and FIG. 4B may be adjusted to the beam angles of each light 4a to 4g for example by adjusting the width of each light control area 11a to 11g.

In case of any changes of the light arrangement 3 as for example a change of the orientation of a light 4a to 4g or a change of the beam angle of a light 4a to 4g, the control unit 6 may readjust the orientation of the light control area assigned to the light according to the changed orientation of the light and may readjust the size of the light control area assigned to the light according to the changed beam angle of the light.

The sensory input device 5 comprises an illuminable first indicator 23 integrated at least partly in the second lighting range control area 13 of each light control area 11a to 11g. The first indicator 23 comprises appropriate illumination means such as LEDs or a display to illuminate the second lighting range control areas 13 of each light control area 11a to 11g individually. The LEDs could be arranged in a light bar for indicating discrete lighting ranges. The display could provide a graphical use interface (GUI) for indicating different lighting ranges. The sensory input device 5 comprises also an illuminable second indicator 29 integrated at least partly in the second lighting range control area 13 of each light control area 11a to 11g. The second indicator 29 may comprise the same illumination means of the first indicator 23 or may comprise separate illumination means. The emitted lights of the first and the second indicator 23 and 29 are of different color so that an operator can visually distinguish the illumination of the first indicator 23 from the illumination of the second indicator 29. So, appropriate illumination means may be multicolor LEDs or a color display. The sensory input device 5 may comprise a transparent cover to protect the first indicator 23 and the second indicator 29.

The first indicator 23 may illuminate the second lighting range control area 13 of each light control area 11a to 11g so that the illuminated area of each second lighting range control area 13 corresponds to the maximum lighting range of the light assigned to the respective second lighting range control area. The second lighting range control areas of the light control areas 11a to 11g illuminated by the first indicator 23 are exemplarily shown in FIG. 4A or FIG. 5: The illuminated area of the second lighting range control area 13 of each light control area 11a to 11g extends to a percentage value corresponding to the percentage value representing the maximum lighting range of the light assigned to the respective light control area. For example, the second lighting range control area 13 assigned to light 4a extends to a percentage value of 67% to indicate that the lighting range of light 4a corresponds to a percentage value of 67% of the overall maximum lighting range. Analogously, the second lighting range control area 13 assigned to lights 4b, 4d, 4e and 4g extend to a percentage value of 75% to indicate that the lighting range of lights 4b, 4d, 4e and 4g correspond to a percentage value of 75% of the overall maximum lighting range. Analogously, the second lighting range control area 13 assigned to lights 4c and 4f extend to a percentage value of 100%.

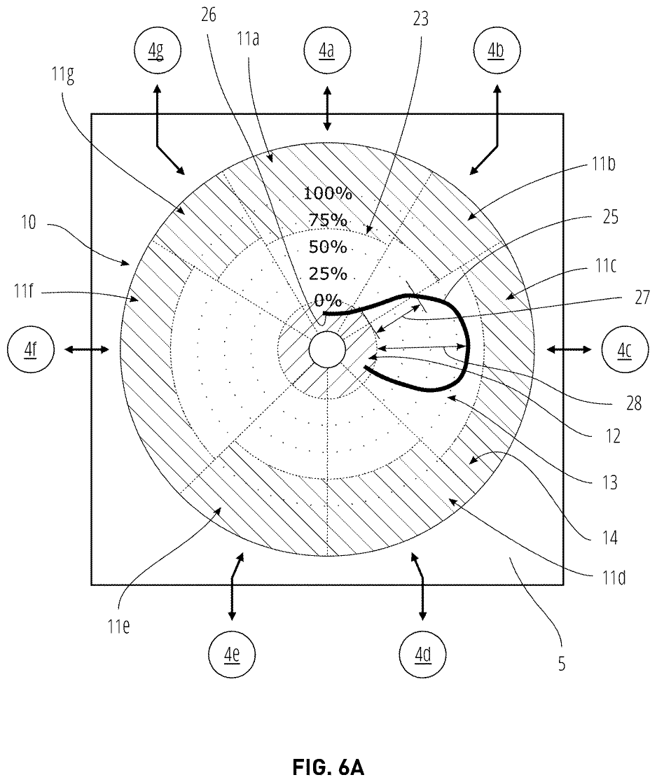

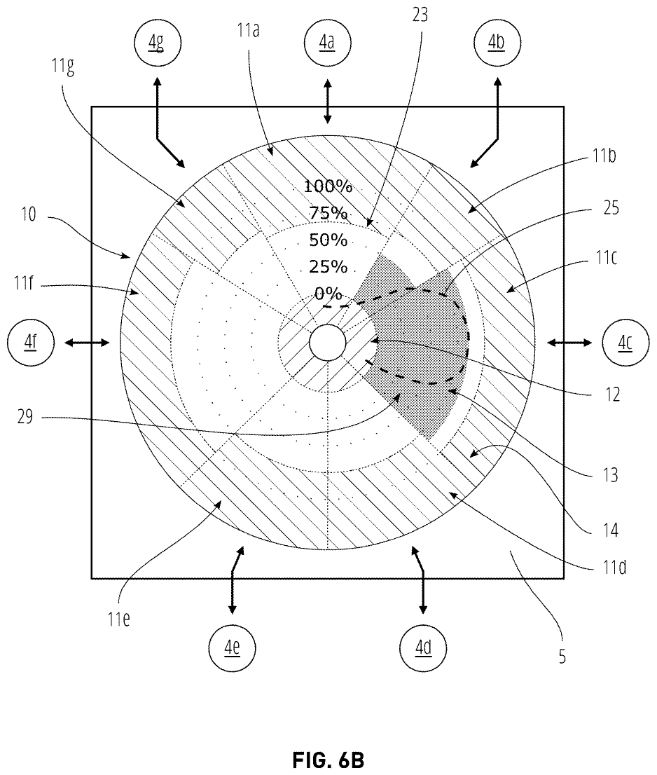

The second indicator 29 may illuminate the second lighting range control area 13 of each light control area 11a to 11g at least partly so that the illuminated area of each second lighting range control area 13 may correspond to the current lighting range of the light assigned to the respective second lighting range control area. FIG. 6B shows the second lighting range control areas assigned to the lights 4b and 4c that are partly illuminated by the second indicator 29: The illuminated area of the second lighting range control area 13 of the light control area 11b assigned to light 4b extends to a percentage value of 50% to indicate that the lighting range of light 4b corresponds to a percentage value of 50% of the overall maximum lighting range of the light arrangement 3. The illuminated area of the second lighting range control area 13 of the light control area 11b also indicates that the percentage value of 50% corresponds to two thirds of the maximum lighting range of the light 4b that corresponds to 75% of the overall maximum lighting range of the light arrangement 3. Thus, the lighting range of the light 4b could be still increased. Analogously, the illuminated area of the second lighting range control area 13 of the light control area 11c assigned to light 4c extends to a percentage value of 84% to indicate that the lighting range of light 4c corresponds to a percentage value of 84% of the overall maximum lighting range of the light arrangement 3. Since the maximum lighting range of the light 4c corresponds to 100% of the overall lighting range of the light arrangement 3 the lighting range of the light 4c could be still increased, too. The second lighting range control areas 13 of the light control areas 11a and 11d to 11g are not illuminated by the second indicator 29 to indicate that the assigned lights 4a and 4d to 4g are switched off.

The first indicator 23 and the second indicator 29 may be of the same type but may illuminate in a different way such as a different color so that an operator can optically distinguish both indicators 23 and 29. For example, the first indicator 23 may emit a white light. The second indicator 29 may emit a light of different color such as a red light. As can be seen in FIG. 6B, both indicators 23 and 29 can illuminate simultaneously the same area of a light control area wherein the area illuminated by the second indicator 29 overlaps the area illuminated by the first indicator 23. Thus, the operator can easily see the current lighting range of each light 4a to 4g in relation to the maximum lighting range of the corresponding light as well as in relation to the overall maximum lighting range of the light arrangement 3.

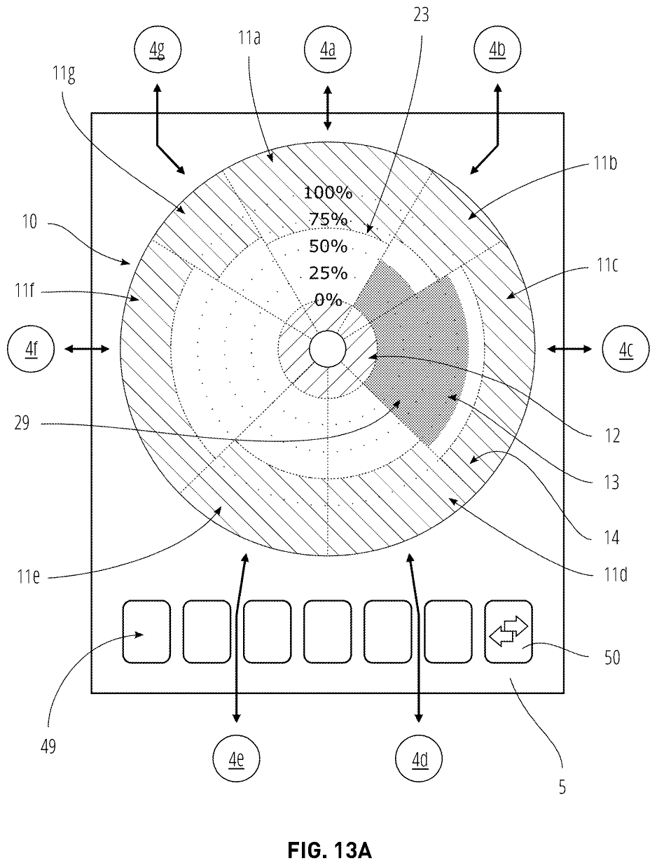

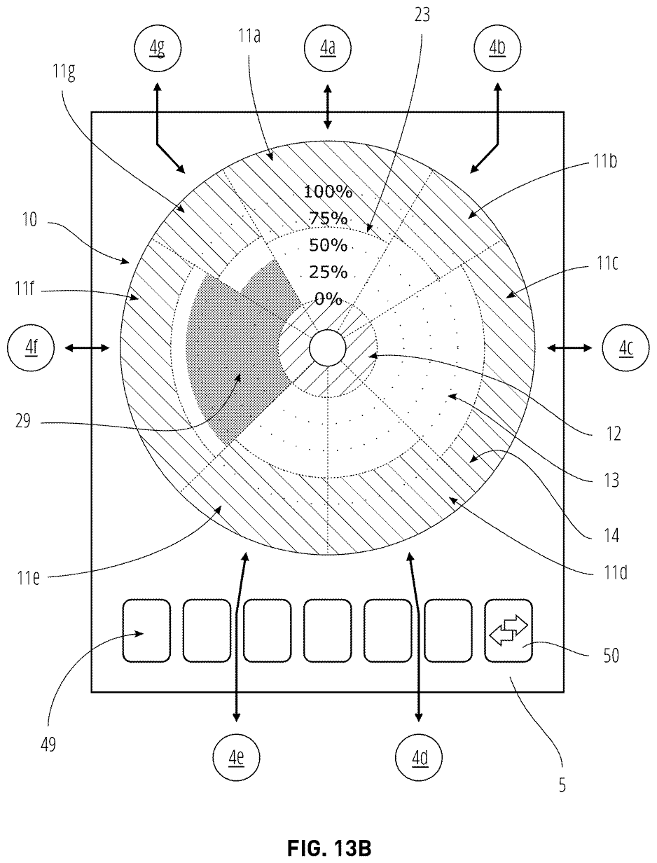

The sensory input device 5 may optionally comprise at least one key 49 as depicted in FIG. 13A. The number of the keys 49 may optionally correspond to the number of lights 4a to 4g.

When a gesture input (see gesture inputs 16, 21 as exemplarily shown in FIG. 4A) is recognized by the sensory input device 5 a corresponding signal is sent to the control unit 6 for processing the gesture input and for controlling the lighting range of the lights 4a to 4g of the light arrangement 3 accordingly. The control unit 6 is configured to control the lights 4a to 4g of the light arrangement 3 independently from each other in response to a single gesture input. As can be exemplarily seen in FIG. 4A, a operator may perform a single gesture input 16 in more than one light control area by moving the finger of his hand 15 from a starting point 17 in the third lighting range control area 14 area of the light control area 11a over the second lighting range control area of the light control area 11b back to the third lighting range control area 14 of the light control area 11c to control the lighting range of the lights 4a, 4b and 4c.

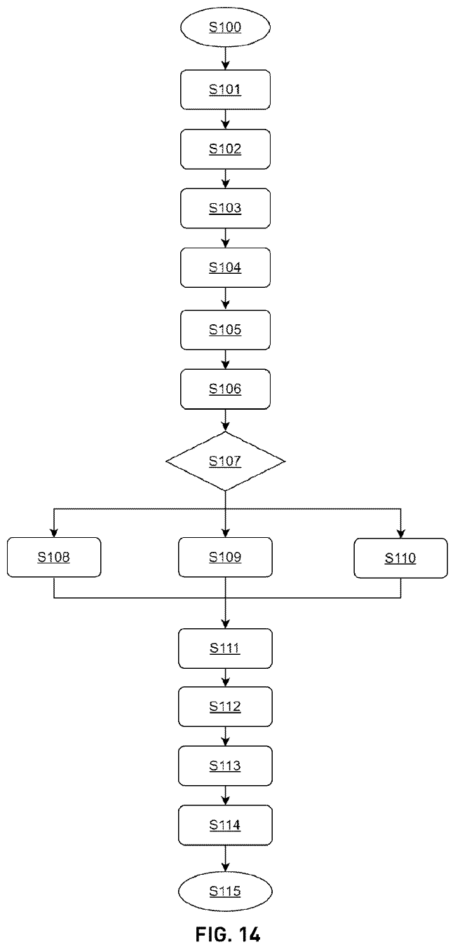

The control unit 6 carries out a method for controlling the lighting ranges of each light 4a to 4g according to a gesture input of an operator. FIG. 14 shows a flow diagram of the method. The method may be a computer-implemented method stored as a computer program product in the memory 8 of the control unit 6. The control unit 6 is configured to carry out the method that may be executed by the controller 7. The method is described by way of example of several steps without any restriction in respect of that steps. I. e. the number or the order of steps may be adapted, for example single steps may be excluded and/or added and executed earlier or later than described. The method starts with step S100 and proceeds to step S101.

At step S101, the control unit 6 determines the maximum lighting range of each light 4a to 4g of the light arrangement 3 and determines the overall maximum lighting range of the light arrangement 3 in dependence of the light of the light arrangement 3 having the greatest maximum lighting range.

The methods proceeds to step S102 and the control unit 6 calibrates the second and third lighting range control areas 13 and 14 of each light control area 11a to 11g in relation to the overall maximum lighting range of the light arrangement 3 and the maximum lighting range of the light assigned to the corresponding light control area. Thus, the control unit 6 adjusts the size of the second lighting range control area 13 of each light control area 11a to 11g according to the maximum lighting range of the corresponding light in relation to the overall maximum lighting range of the light arrangement 3. Optionally, the size of the third lighting range control area 14 of each light control area 11a to 11g is adjusted in relation to the respective second lighting range control area 13.

The control unit 6 may also determine the direction each light 4a to 4g of the light arrangement 3 is oriented and the beam angle of each light 4a to 4g. The information about the orientations and the beam angles of the lights 4a to 4g may be stored in the memory 8 of the control unit 6 to be read out by the controller 7. Based on the information of the orientation of each light 4a to 4g, the control unit 6 adapts the orientation of the light control areas 11a to 11g so that the orientation of a light corresponds with the orientation of the light control area assigned to the light. In addition, based on the information of the beam angle of each light 4a to 4g, the control unit 6 may adapt the size of the light control areas 11a to 11g so that the beam angle of a light corresponds with the size of the light control area assigned to the light. In case of circular light control areas 11a to 11g, the angle of the circular shape of a light control area may be adjusted according to the beam angle of the light assigned to the light control area (see FIG. 5). In case of rectangular light control areas, the width of a light control area may be adjusted according to the beam angle of the light assigned to the light control area.

Then the control unit 6 controls the first indicator 23 to indicate the maximum lighting range of each light 4a to 4g. As a result, the first indicator 23 may illuminate the second lighting range control area 13 of each light control area 11a to 11g as exemplarily shown in FIG. 5. Since the second lighting range control areas 13 are calibrated the area illuminated by the first indicator 23 represents visually the calibrated maximum lighting range of each light 4a to 4g.

The method proceeds to step S103 and the control unit 6 receives signals sent from the sensory input device 5 due to a gesture input of the operator.

The method proceeds to step S104 and the control unit 6 determines whether the gesture input was started in a first, a second or a third lighting range control area 12, 13 or 14 and if so in which of the first lighting range control areas 12, second lighting range control areas 13 or third lighting range control areas 14 the gesture input was started. As exemplarily shown in FIG. 4A, the control unit 6 would determine that the gesture input 16 was started in the third lighting range control area 14 of the light control area 11a due to the starting point 17. But an alternative gesture input 21 may have a starting point 22 so that the control unit 6 would determine that the gesture input 21 was started in the first lighting range control area 12 of the light control area 11e.

The method proceeds to step S105 and the control unit determines whether a gesture input recognized in the light control area of the assigned light is located in the first lighting range control area 12 of the light control area of the assigned light only or whether a gesture input recognized in the light control area of the assigned light is located in the third lighting range control area 14 of the light control area of the assigned light only. As can be exemplarily seen in FIG. 6A, a gesture input 25 extends out of the first lighting range control area 12 not until after the light control area 11a: The gesture input 25 is located in the first lighting range control area 12 of the light control area 11a of the assigned light 4a without extending into the other lighting range control areas 13 or 14 of the corresponding light control area 11a. Thus, the control unit 6 determines that gesture input 25 recognized in the first light control area 11a of the assigned light 4a is located in the first lighting range control area 12 of the light control area 11a of the assigned light 4a only.

Then, the control unit 6 switches off any light 4a to 4g if a gesture input recognized in the light control area of the assigned light is located in the first lighting range control area 12 of the light control area of the assigned light only and sets the lighting range of the light to the maximum lighting range of the corresponding light if a gesture input recognized in the light control area of the assigned light is located in the third lighting range control area 14 of the light control area of the assigned light only. I. e. in case of gesture input 25, the light 4a is switched off.

Next to gesture inputs performed in the first or third lighting range control areas 12 or 14 of the lights 4a to 4g only, also gesture inputs being at least partly performed in the second lighting range control area 13 can be processed by the control unit 6 to set a lighting range of at least one of the lights 4a to 4g independently from any other light of the light arrangement 3 in response to a single gesture input as described in the following method steps.

The method proceeds to step S106 and the control unit 6 determines whether the recognized gesture input extends into the second lighting range control area 13 at any light control area 11a to 11g. As can be exemplarily seen in FIG. 4A, a part of the gesture input 16 is located in the second lighting range control area 13 of the light control areas 11a, 11b and 11c assigned to lights 4a, 4b and 4c as well as a part of the gesture input 21 is located in the second lighting range control area 13 of the light control area 11e assigned to light 4e. Thus, the control unit 6 processes the gesture input 16 and the gesture input 21 to determine a demanded lighting range for each of the lights 4a, 4b and 4c according to the single gesture input 16 and to determine a demanded lighting range for the light 4e according to the single gesture input 21 that have been recognized in the second lighting range control areas 13 of the assigned lights 4a, 4b, 4c and 4e.

The determination of the demanded lighting range depends on the lighting range control area in which the starting point of the gesture input was determined (see step S104). The method proceeds to step S107 and the control unit 6 decides with which subsequent steps the method will proceed to determine the demanded lighting range for each of the lights 4a to 4g.

If the starting point of the gesture input is located in the first lighting range control area 12 the method proceeds with step S108. If the starting point of the gesture input is located in the second lighting range control area 13 the method proceeds with step S109. If the starting point of the gesture input is located in the third lighting range control area 14 the method proceeds with step S110. As can exemplarily be seen in FIG. 4A, the starting point 17 of the gesture input 16 is located in the third lighting range control area 14 and the starting point 22 of the gesture input 21 is located in the first lighting range control area 12. So, the control unit 6 determines the demanded lighting ranges for each of the lights 4a, 4b and 4c according to step S110 and the demanded lighting range for the light 4e according to step S108.

The demanded lighting range for a light 4a to 4g is exemplarily expressed by a percentage value between 0 and 100% of the overall maximum lighting range of the light arrangement 3. I. e., a demanded lighting range of 0% corresponds to a status of emitting no light, a demanded lighting range of 100% corresponds to the lighting range of the light of the light arrangement 3 having the greatest maximum lighting range and a demanded lighting range of any other percentage value corresponds to a lighting range according to the percentage value in respect of the overall maximum lighting range. Since not all lights of the light arrangement 3 may provide a maximum lighting range corresponding to the overall maximum lighting range, the demanded lighting range may be greater than the maximum lighting range of a light. In such a case, the demanded lighting range would demand a lighting range according to the maximum lighting range of the respective light. Alternatively, the demanded lighting range can be defined by absolute values instead of percentage values as for example values in meters or any other unit of length.

At step S108, the control unit 6 determines the demanded lighting range of a light according to a maximum displacement of the gesture input in the second lighting range control area 13 of the assigned light started from the first lighting range control area 12. As exemplarily shown in FIG. 4A, the maximum displacement of the gesture input 21 in the second lighting range control area 13 of the assigned light 4e started from the first lighting range control area 12 is indicated by the maximum displacement 24 corresponding with a percentage value of 33%. Thus, the control unit 6 sets the demanded lighting range for light 4e to the percentage value of the maximum displacement 18 of 33%.

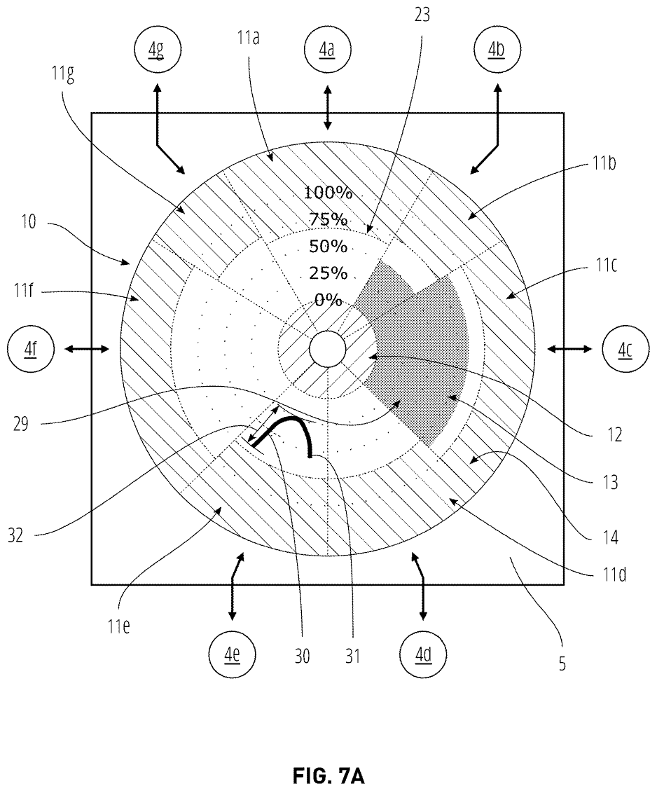

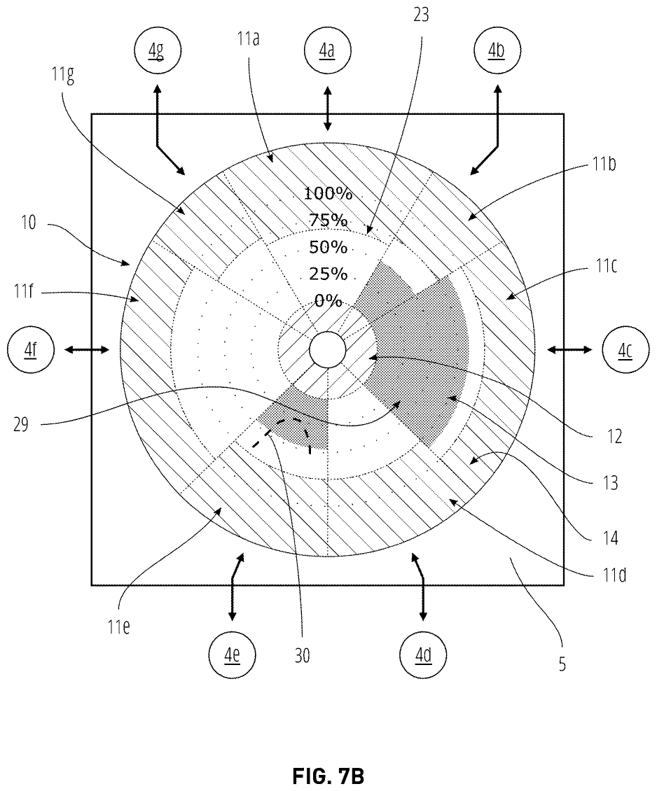

At step S109, the control unit 6 determines the demanded lighting range of a light according to a median of a displacement of the gesture input in the second lighting range control area 13 of the assigned light if a starting point of the gesture input was detected in the second lighting range control area 13. As exemplarily shown in FIG. 7A, a gesture input 30 with a starting point 31 in the second lighting range control area 13 of the assigned light 4e reaches from a maximum percentage value of 68% in the second lighting range control area 13 to a minimum percentage value of 24% in the second lighting range control area 13. This may result to a median displacement having a percentage value of 46%. Alternatively, an arithmetic mean or an integral of the values of the gesture input may be determined for the median displacement which may lead to different percentage values. Thus, the control unit 6 sets the demanded lighting range for light 4e to the value of the median displacement of 46%.

At step S110, the control unit 6 determines the demanded lighting range of a light according to a maximum displacement of the gesture input in the second lighting range control area 13 of the assigned light started from the third lighting range control area 14. As exemplarily shown in FIG. 4A, the maximum displacement of the gesture input 16 in the second lighting range control area 13 of the assigned light 4a started from the third lighting range control area 14 is indicated by the maximum displacement 18 corresponding with percentage value of 48%. Thus, the control unit 6 sets the demanded lighting range for light 4a to the value of the maximum displacement 18 of 48%. The maximum displacement of the gesture input 16 in the second lighting range control area 13 of the assigned light 4b started from the third lighting range control area 14 is indicated by the maximum displacement 19 corresponding with a percentage value of 27%. Thus, the control unit 6 sets the demanded lighting range for light 4b to the percentage value of the maximum displacement 19 of 27%. The maximum displacement of the gesture input 16 in the second lighting range control area 13 of the assigned light 4c started from the third lighting range control area 14 is indicated by the maximum displacement 20 corresponding with a percentage value of 60%. Thus, the control unit 6 sets the demanded lighting range for light 4c to the value of the maximum displacement 20 of 60%. Hence, one single gesture input can be used to determine individually a demanded lighting range for each of the lights of the light arrangement 3.

FIG. 6A shows as another example a gesture input 25 with a starting point 26 in the first lighting range control area 12 of the light control area 11a. The gesture input 25 enters the second lighting range control area 13 of the light control area 11b and reaches a maximum displacement 27 corresponding with a percentage value of 50% from the first lighting range control area 12. Then, the gesture input 25 enters the second lighting range control area 13 of light control area 11c and reaches a maximum displacement 28 corresponding to a percentage value of 84%. The gesture input 25 ends in the first lighting range control area 12 of the light control area 11c. Thus, the control unit 6 determines a demanded lighting range of a percentage value of 0% for light 4a, a demanded lighting range of a percentage value of 50% for light 4b and a demanded lighting range of a percentage value of 84% for light 4c according to step S108.

Once a demanded lighting range for a light 4a to 4g has been determined the method proceeds to step S111 and the control unit sets the lighting range of the corresponding light 4a to 4g according to the demanded lighting range. The lighting range of the light may be set in different ways. For example, if the light whose lighting range shall be set is a dimmable light the lighting range of this light may continuously be adjusted according to the percentage value of the demanded lighting range.

Alternatively, the light may be adjusted stepwise for increasing or decreasing the lighting range of the light by a predefined step of for example 10%. So, the lighting range of the light may be set to 0%, 10%, 20%, . . . , 90%, 100%. In case of a non-dimmable light the light may be switched on if the demanded lighting range is greater than a switching threshold or switched off if the demanded lighting range is smaller (or equal) than the switching threshold. The switching threshold may correspond to 50% of the maximum lighting range of the respective light. If the demanded lighting range for a light is greater than the maximum lighting range of the light then the lighting range of the light is set to the maximum lighting range of the light.

By way of example of FIG. 6A, the control unit 6 switches off the light 4a and sets the lighting range of light 4b to 50% of the overall maximum lighting range of the light arrangement 3 and sets the lighting range of light 4c to 84% of the overall maximum lighting range of the light arrangement 3.

Once the lighting ranges of each light 4a to 4g have been set by the control unit 6 according to the demanded lighting ranges, the method proceeds to step S112 for controlling the second indicator 29 to adjust the illumination of the second lighting range control areas of each light 4a to 4g according to the lighting ranges of each light 4a to 4g. As shown in FIG. 6A for example, the control unit 6 set the lighting range of light 4b according to the demanded lighting range of a percentage value of 50%. Thus, the control unit 6 controls the second indicator 29 to illuminate the second lighting range control area 13 assigned to the light 4b up to a percentage value of 50% as shown in FIG. 6B. The control unit 6 set the lighting range of light 4c according to the demanded lighting range of a percentage value of 84%. Thus, the control unit 6 controls the second indicator 29 to illuminate the second lighting range control area 13 assigned to the light 4c up to a percentage value of 84% as shown in FIG. 6B. Since the demanded lighting range for light 4a resulted in switching off the light 4a, the control unit 6 controls the second indicator 29 not to illuminate the second lighting range control area 13 assigned to light 4a. Instead, the second lighting range control area 13 assigned to light 4a may be illuminated by the first indicator 23 only.

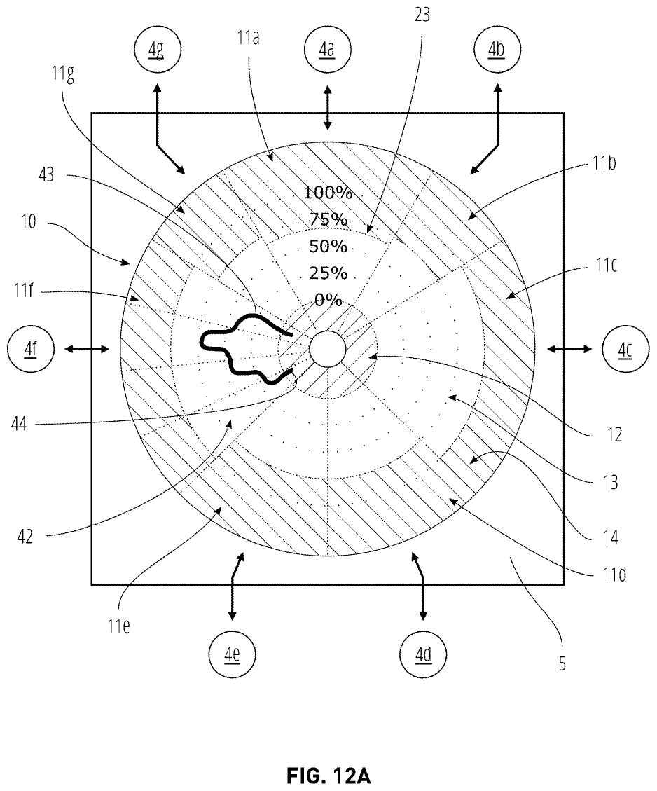

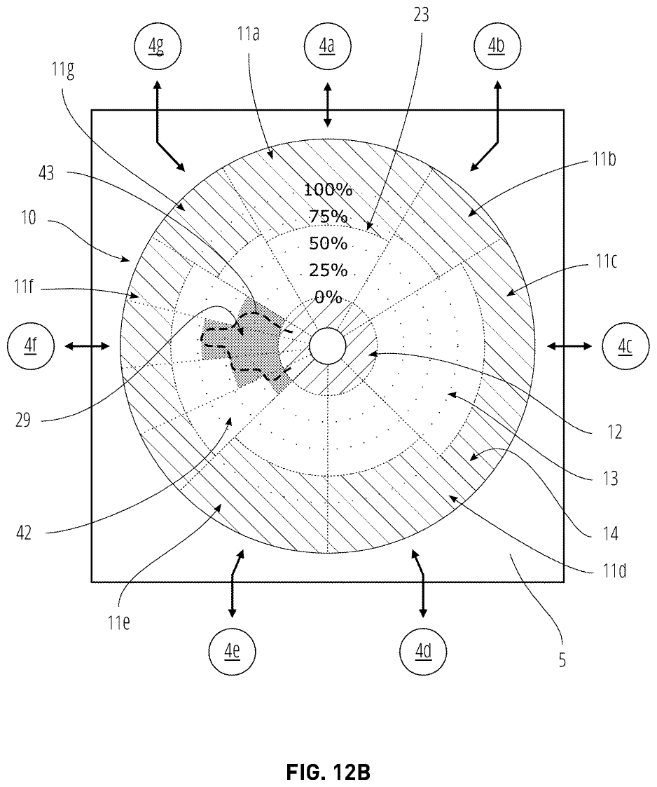

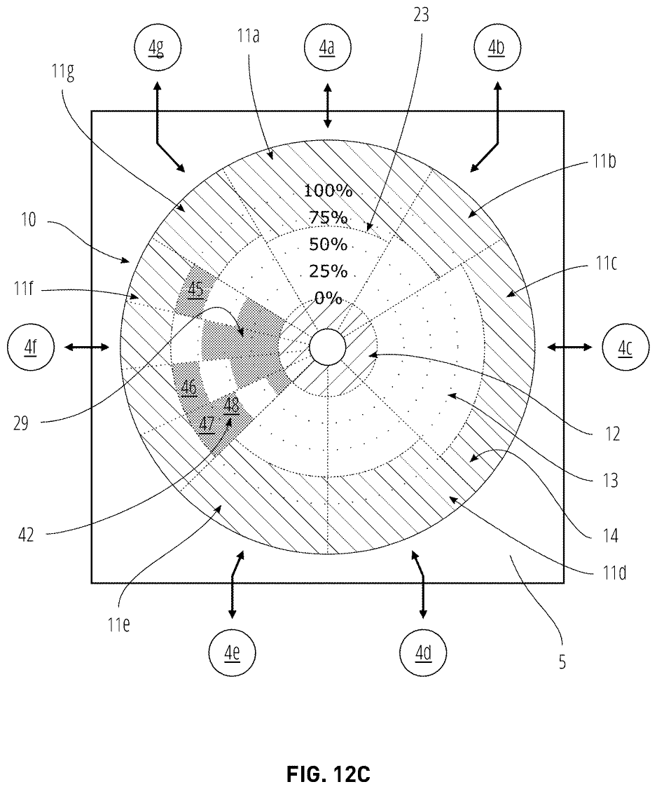

At least one of the lights 4a to 4g of the light arrangement 3 may be a matrix light having two or more light elements. The lighting ranges of the light elements of the matrix light can be individually controlled such as separate lights. So, the method steps described above for controlling the lighting range of a light can be analogously applied to control each individual light element of a matrix light. For example, light 4f is designed as a matrix light having 16 light elements arranged in a 4×4 matrix. As exemplarily shown in FIG. 12A, the second lighting range control area 13 of the light control area 11f assigned to the matrix light 4f comprises a number of switch fields corresponding to the number of light elements of the matrix light 4f. The switch fields of the light control area 11f assigned to the matrix light 4f are also arranged in a 4×4 matrix matching with the 4×4 matrix of the light elements of the matrix light 4f. The control unit 6 receives a gesture input 43 performed by an operator in the light control area 11f assigned to the matrix light 4f and determines a starting point 44 of the gesture input 43. The control unit 6 determines for each light element arranged in the 4×4 matrix a demanded lighting range according to the method steps as described above. As exemplarily can be seen in FIG. 12B, the control unit 6 sets the lighting range of each light element of the matrix light 4f according to the lighting range of each light element and illuminates the second lighting range control area 13 assigned to the matrix light 4f accordingly. Additionally, the operator may switch on or off single light elements of the matrix light 4f by tipping his finger in a corresponding switch field of the second lighting range control area 13 of the light control area 11f. As can be exemplarily seen in FIG. 12C, the operator may tip in the switch fields 45, 46, 47 or 48 to switch on the light elements of the matrix light 4f assigned to the respective switch fields 45 to 48.

Analogously, the operator may switch off a light element of the matrix light 4f by tipping in a switch field assigned to any one of the light emitting light elements of the matrix light 4f.

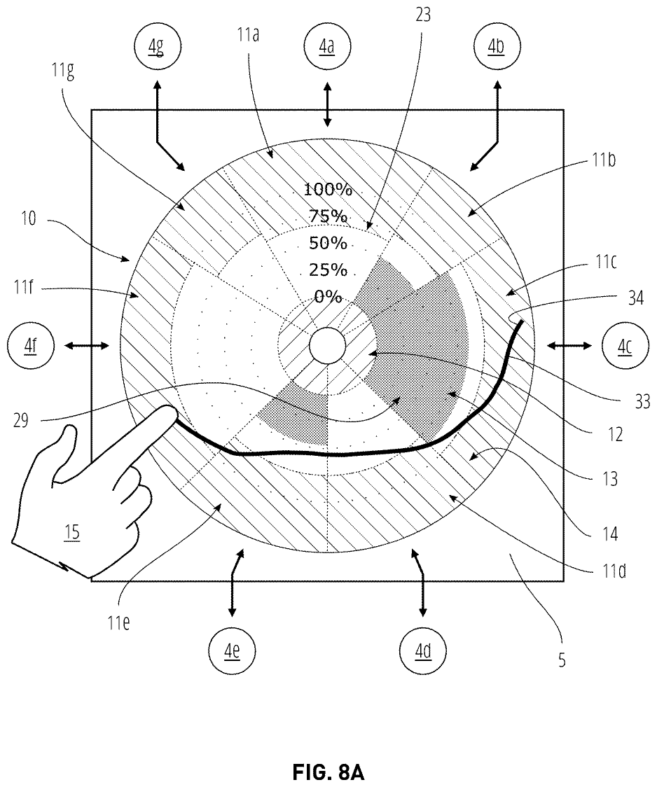

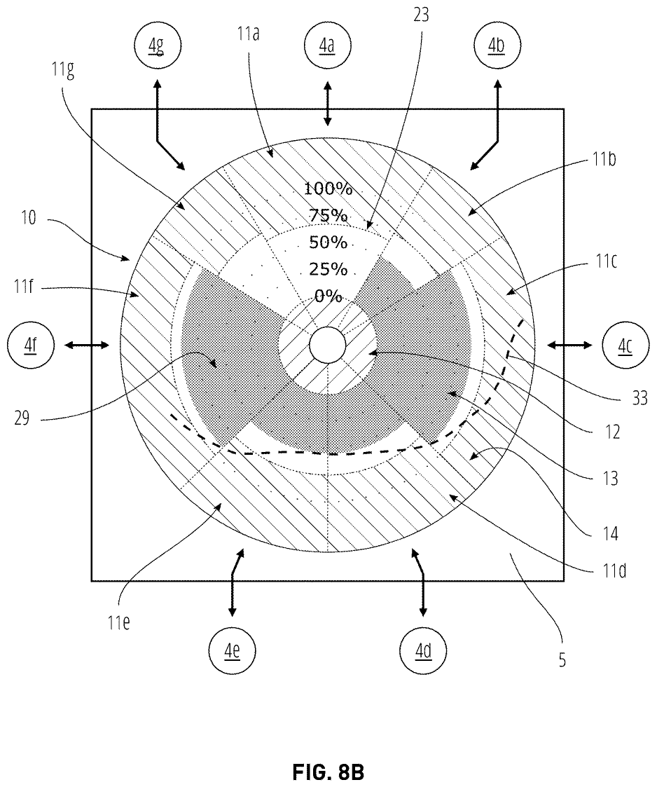

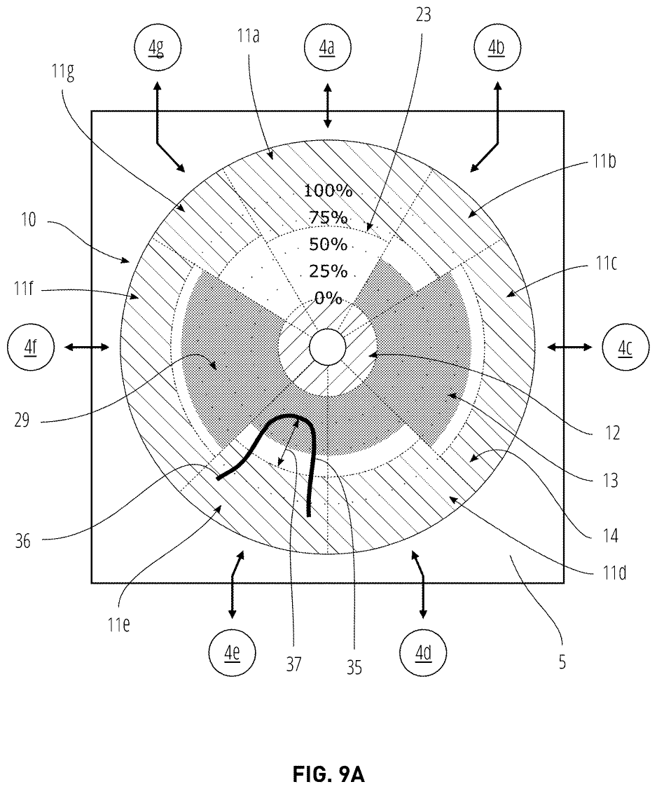

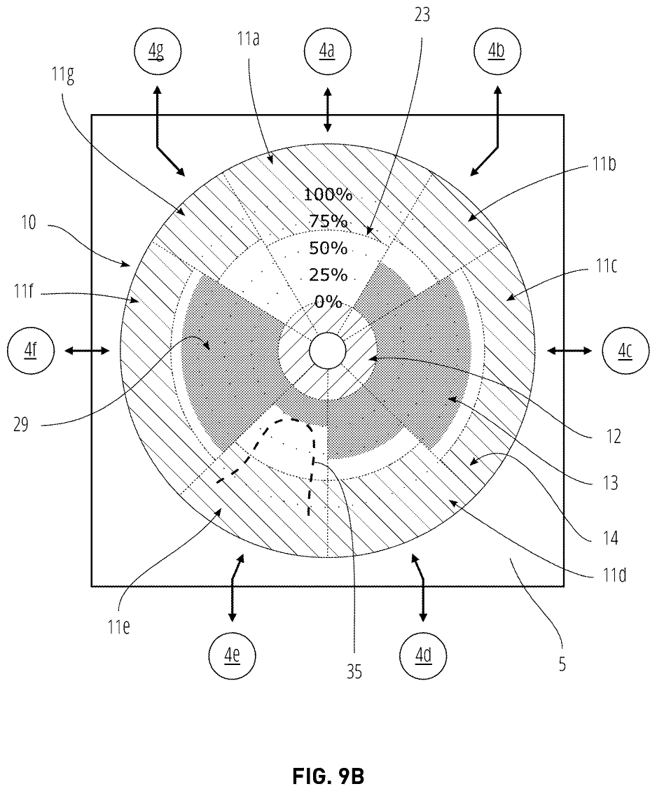

As mentioned above, the sensory input device 5 may optionally comprise keys 49 as depicted in FIG. 13A. For example, the sensory input device 5 comprises seven keys 49. Each key 49 may be programmable so that a specific lighting setting of one or more lights 4a to 4g can be stored to the memory 8 of the control unit 6 and assigned to one of the keys 49. The operator may store a lighting setting by pressing a key 49 longer than a predefined time limit such as for example two seconds. The operator may store any lighting setting as for example shown in FIG. 6B, FIG. 7B, FIG. 8B, FIG. 9B or any other setting.

If the control unit 6 detects that the operator is programming a key 49 the method proceeds to step S113 and the control unit 6 determines the lighting ranges of the lights 4a to 4g, stores the lighting ranges to the memory 8 and assigns the lighting ranges to the key 49 programmed by the operator. Then, the operator may use the key 49 as a short-key for restoring the previously saved lighting setting. I. e. the operator may press the programmed key 49 again (shorter than the predefined time limit) and the control unit 6 sets the lighting ranges of each of the lights 4a to 4g according to the saved lighting setting assigned to the key 49.

The key 49 may comprise a display to show the lighting setting being assigned to the key. For example, if a lighting setting as indicated by the second indicator 29 in FIG. 6B is assigned to the key 49, the display of the key 49 would show a lighting setting corresponding to the indication of the second indicator 29 in FIG. 6B.

The sensory input device 5 may optionally comprise a swap key 50 as shown in FIG. 13A and FIG. 13B. The swap key 50 is preconfigured and causes a swapping of the lighting setting of the lights 4b, 4c and 4d at a right side of the light arrangement 3 with the lighting setting of the lights 4g, 4f and 4e at a left side of the light arrangement 3 if the swap key 50 is pressed. I. e., the control unit 6 recognizes if the swap key 50 is pressed and in response thereof, the control unit 6 sets the current lighting range of light 4b (FIG. 13A) as a new lighting range of light 4g (FIG. 13B) as well as the current lighting range of light 4g (FIG. 13A) as a new lighting range of light 4b (FIG. 13B), and sets the current lighting range of light 4c (FIG. 13A) as a new lighting range of light 4f (FIG. 13B) as well as the current lighting range of light 4f (FIG. 13A) as a new lighting range of light 4c (FIG. 13B), and sets the current lighting range of light 4d (FIG. 13A) as a new lighting range of light 4e (FIG. 13B) as well as the current lighting range of light 4e (FIG. 13A) as a new lighting range of light 4d (FIG. 13B). As can be seen in FIG. 13B, the control unit 6 controls the second indicator 29 to adjust the illuminated areas of the second lighting range control areas 13 accordingly. A swapping of the lighting setting of the lights 4b, 4c and 4d at the right side of the light arrangement 3 with the lighting setting of the lights 4g, 4f and 4e at the left side of the light arrangement 3 may be executed by the control unit 6 automatically, for example in response to a change of the driving direction of the vehicle 1 from one direction (e. g. direction to the north) to an opposite direction (direction to the south).

Optionally, the method proceeds to step S114 and the control unit 6 determines the number of the lights 4a to 4g of the light arrangement 3. As shown in FIG. 1 and FIG. 2, the light arrangement 3 comprises seven lights 4a to 4g assigned to the seven light control areas 11a to 11g of the sensor area 10. But an operator may add an additional light to the light arrangement 3 or remove a light from the light arrangement 3 so that the number of the light arrangement 3 may change. Then, the control unit 6 can determine the number of the lights of the light arrangement 3 again. The control unit 6 checks also whether the number of the light control areas 11a to 11g corresponds to the number of the lights of the light arrangement 3 and adjusts the number of light control areas according to the number of lights of the light arrangement 3 if the number of light control areas deviates from the number of the lights of the light arrangement 3. The control unit 6 may add or remove a light control area by adjusting the segmentation of the sensor area 10. The segmentation of the light control areas may be displayed to the operator by a display integrated in the sensory input device 5. Additionally, the control unit 6 may update the overall maximum lighting range of the light arrangement 3 and may recalibrate the second and the third lighting range control areas 13 and 14 in respect of the updated overall maximum lighting range. In addition, the control unit 6 may readjust the orientations of the light control areas 11a to 11g assigned to the lights 4a to 4g according to changed orientations of the lights 4a to 4g and may readjust the sizes of the light control areas 11a to 11g assigned to the lights 4a to 4g according to the changed beam angles of the lights 4a to 4g.

Finally, the method proceeds to step S115 and ends. The method may be restarted by the control unit 6 again.

It is assumed now that all lights 4a to 4g of the light arrangement 3 are switched off. The second lighting range control areas 13 of the light control areas 11a to 11g are illuminated by the first indicator 23 to indicate the maximum lighting range of each light 4a to 4g in respect of the overall maximum lighting range of the light arrangement 3. The second indicator 29 does not illuminate any second lighting range control area 13 since all lights 4a to 4g are switched off as can be seen in FIG. 5.

As an example of use as depicted in FIG. 6A, an operator may perform an input gesture input 25 on the sensor area 10 of the sensory input device 5 starting at the starting point 26 in the first lighting range control area 12 of the light control area 11a assigned to the light 4a. The gesture input 25 stays in the first lighting range control areas 12 of the light control area 11a and extends into the second lighting range control areas 13 of the light control areas 11b and 11c. The gesture input 25 ends in the light control area 11c. The control unit 6 receives the gesture input 25 from the sensory input device 5 and processes the gesture input 25 by executing method steps as described above to determine a demanded lighting range for each of the lights 4a to 4g and to set the lighting ranges of the lights 4a to 4g accordingly.

Since the gesture input 25 started in one of the first lighting range control areas 12, the control unit 6 determines a maximum displacement 27 of the gesture input 25 from the first lighting range control area 12 in the light control area 11b and a maximum displacement 28 of the gesture input 25 from the first lighting range control area 12 in the light control area 11c. Based on the maximum displacements 27 and 28, the control unit 6 determines a demanded lighting range of a percentage value of 50% for light 4b and a demanded lighting range of a percentage value of 84% for the light 4c.

FIG. 6B shows to which percentage values the lighting ranges of the lights 4a to 4g represented by the second indicator 29 of the corresponding light control areas are set by the control unit 6 in response to the gesture input 25. The lighting range of light 4a is set to a percentage value of 0% since the control unit 6 couldn't determine that the gesture input 25 extends into the second or third lighting range control areas 13 or 14 of the light control area 11a. So, light 4a is switched off. The lighting range of light 4b is set to a percentage value of 50% according to the demanded lighting range for light 4b and the lighting range of light 4c is set to a percentage value of 84% according to the demanded lighting range for light 4c. Thus as can be seen, the lighting ranges of the lights 4b and 4c can be changed by a single gesture input.

As can be seen in FIG. 7A, the operator performs another gesture input 30 on the sensor area 10 based on the lighting setting of FIG. 6B. The gesture input 30 starts at starting point 31 in the second lighting range control area 13 of the light control area 11e assigned to the light 4e. The gesture input 30 ends in the light control area 11e. The control unit 6 receives the gesture input 30 from the sensory input device 5 and processes the gesture input 30 by executing method steps as described above to determine a demanded lighting range for each of the lights 4a to 4g and to set the lighting ranges of the lights 4a to 4g accordingly.

Since the gesture input 30 started in one of the second lighting range control area 13, the control unit 6 determines a maximum percentage value of 68% of the gesture input 30 in the second lighting range control area 13 and a minimum percentage value of 24% of the gesture input 30 in the second lighting range control area 13. Then, the control unit 6 determines a median displacement of the gesture input 30. The median displacement may depend on the method of calculating a mean value, for example determining an arithmetic mean, geometric mean or an integral. The median displacement may have a percentage value of 46% based on the maximum percentage value of 68% and the minimum percentage value of 24%. Based on these median displacement, the control unit 6 determines a demanded lighting range of a percentage value of 46% for light 4e. If another method is used for determining the median displacement, such as an arithmetic mean or an integral, a different percentage value may be determined.

FIG. 7B shows to which percentage values the lighting range of the light 4e represented by the second indicator 29 of the corresponding light control areas is set by the control unit 6 in response to the gesture input 38. The lighting ranges of the lights 4a, 4b, 4c, 4d, 4f and 4g aren't changed because the control unit 6 couldn't determine a gesture input in the light control areas 11a, 11b, 11c, 11d, 11f and 11g. The lighting range of light 4e is set to a percentage value of 46% according to the demanded lighting range for light 4e.

As can be seen in FIG. 8A, the operator performs another gesture input 33 on the sensor area 10 based on the lighting setting of FIG. 7B. The gesture input 33 starts at the starting point 34 in the third lighting range control area 14 of the light control area 11c assigned to the light 4c. The gesture input 33 extends into the second lighting range control areas 13 of the light control areas 11c, 11d, 11e and 11f. The gesture input 33 ends in the light control area 11f. The control unit 6 receives the gesture input 33 from the sensory input device 5 and processes the gesture input 33 by executing method steps as described above to determine a demanded lighting range for each of the lights 4a to 4g and to set the lighting ranges of the lights 4a to 4g accordingly.

Since the gesture input 33 started in one of the third lighting range control areas 14, the control unit 6 determines a maximum displacement of the gesture input 33 from the third lighting range control area 14 in the light control area 11c, a maximum displacement of the gesture input 33 from the third lighting range control area 14 in the light control area 11d, a maximum displacement of the gesture input 33 from the third lighting range control area 14 in the light control area 11e and a maximum displacement of the gesture input 33 from the third lighting range control area 14 in the light control area 11f. Based on these maximum displacements, the control unit 6 determines a demanded lighting range of a percentage value of 86% for light 4c, a demanded lighting range of a percentage value of 54% for light 4d, a demanded lighting range of a percentage value of 53% for the light 4e and a demanded lighting range of a percentage value of 91% for the light 4f.

FIG. 8B shows to which percentage values the lighting ranges of the lights 4a to 4g represented by the second indicator 29 of the corresponding light control areas are set by the control unit 6 in response to the gesture input 33. The lighting ranges of the lights 4g, 4a and 4b aren't changed because the control unit 6 couldn't determine a gesture input in the light control areas 11g, 11a and 11b and didn't determine demanded lighting ranges for the lights 4a, 4b and 4g. The lighting range of light 4c is set to a percentage value of 86% according to the demanded lighting range for light 4c. The lighting range of light 4d is set to a percentage value of 54% according to the demanded lighting range for light 4d. The lighting range of light 4e is set to a percentage value of 53% according to the demanded lighting range for light 4e. The lighting range of light 4f is set to a percentage value of 91% according to the demanded lighting range for light 4f.

As can be seen in FIG. 9A, the operator performs another gesture input 35 on the sensor area 10 based on the lighting setting of FIG. 8B. The gesture input 35 starts at the starting point 36 in the third lighting range control area 14 of the light control area 11e assigned to the light 4e. The gesture input 35 extends into the second lighting range control area 13 of the light control area 11e. The gesture input 35 ends in the light control area 11e. The control unit 6 receives the gesture input 35 from the sensory input device 5 and processes the gesture input 35 by executing method steps as described above to determine a demanded lighting range for each of the lights 4a to 4g and to set the lighting ranges of the lights 4a to 4g accordingly.

Since the gesture input 35 started in one of the third lighting range control areas 14, the control unit 6 determines a maximum displacement 37 of the gesture input 35 from the third lighting range control area 14 in the light control area 11e. Based on the maximum displacement 37, the control unit 6 determines a demanded lighting range of a percentage value of 25% for light 4e.

FIG. 9B shows to which percentage values the lighting ranges of the lights 4a to 4g represented by the second indicator 29 of the corresponding light control areas are set by the control unit 6 in response to the gesture input 35. The lighting ranges of the lights 4a, 4b, 4c, 4d, 4f and 4g aren't changed because the control unit 6 couldn't determine a gesture input in the light control areas 11a, 11b, 11c, 11d, 11f and 11g and didn't determine a demanded lighting range for the lights 4a, 4b, 4c, 4d, 4f and 4g. The lighting range of light 4e is set to a percentage value of 25% according to the demanded lighting range for light 4e.

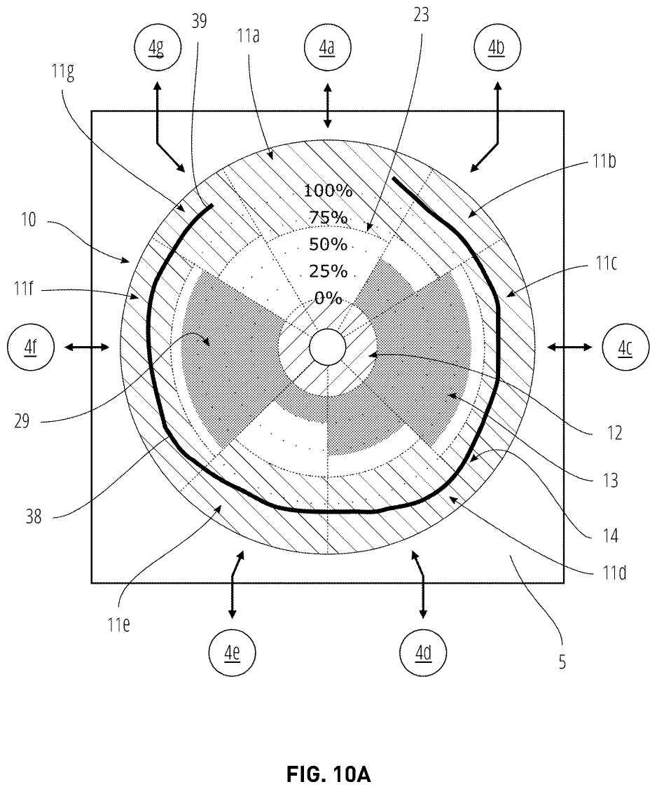

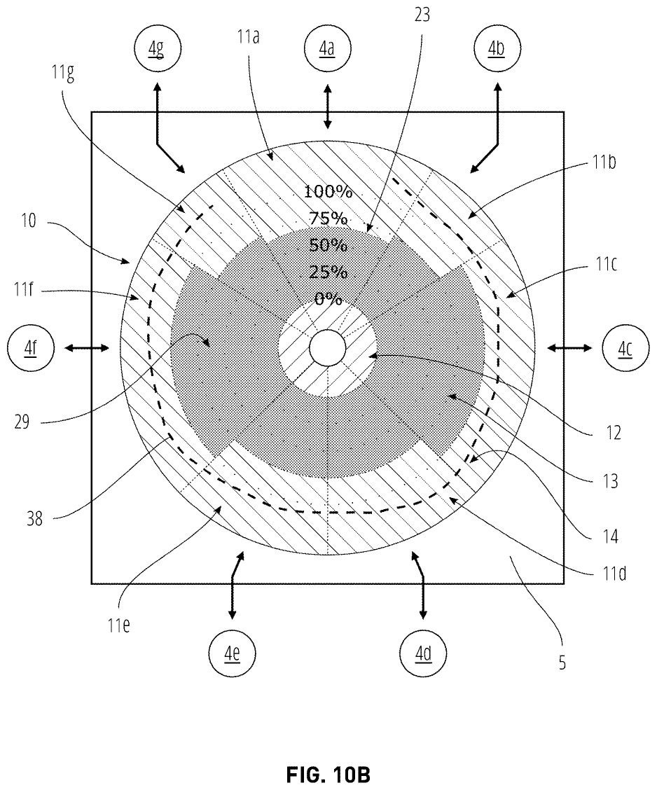

As can be seen in FIG. 10A, the operator performs another gesture input 38 on the sensor area 10 based on the lighting setting of FIG. 9B. The gesture input 38 starts at the starting point 39 in the third lighting range control area 14 of the light control area 11g assigned to the light 4g and ends in the light control area 11a. The gesture input 38 stays in the third lighting range control area 14 of the light control areas 11a to 11g and doesn't extend into any first or second lighting range control area 12 or 13. The control unit 6 receives the gesture input 38 from the sensory input device 5 and processes the gesture input 38 by executing method steps as described above to determine a demanded lighting range for each of the lights 4a to 4g and to set the lighting ranges of the lights 4a to 4g accordingly.

Since the gesture input 38 stays in the third lighting range control area 14 of each light 4a to 4g, the control unit 6 determines maximum lighting range as a demanded lighting range for each of the lights 4a to 4g.

FIG. 10B shows to which percentage values the lighting ranges of the lights 4a to 4g represented by the second indicator 29 of the corresponding light control areas are set by the control unit 6 in response to the gesture input 38. The lighting ranges of the lights 4a to 4g are set each to maximum lighting range according to the demanded lighting ranges for the lights 4a to 4g.

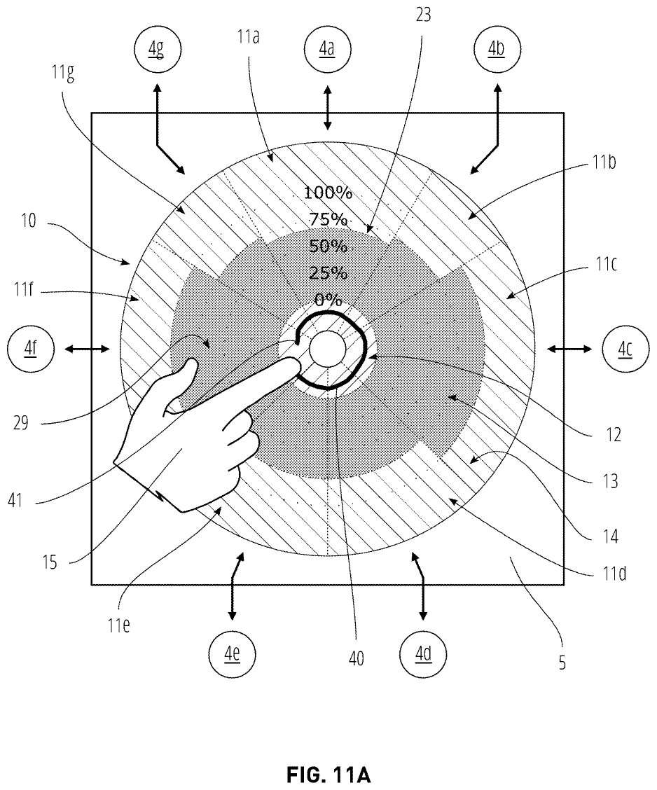

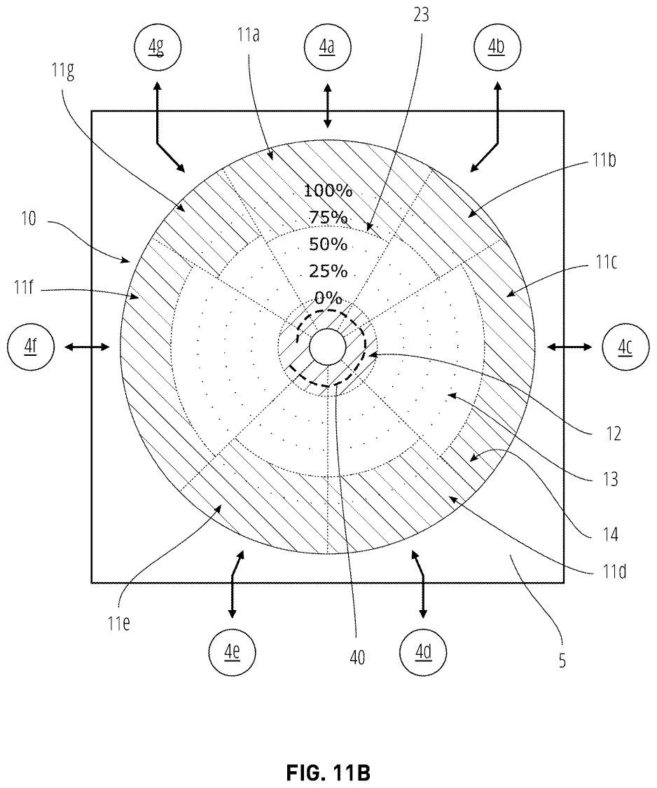

As can be seen in FIG. 11A, the operator performs another gesture input 40 on the sensor area 10 based on the lighting setting of FIG. 10B. The gesture input 40 starts at the starting point 41 in the first lighting range control area 12 of the light control area 11f assigned to the light 4f and ends also in the light control area 11f. The gesture input 40 stays in the first lighting range control area 12 of the light control areas 11a to 11g and doesn't extend into any second or third lighting range control area 13 or 14. The control unit 6 receives the gesture input 40 from the sensory input device 5 and processes the gesture input 40 by executing method steps as described above to determine a demanded lighting range for each of the lights 4a to 4g and to set the lighting ranges of the lights 4a to 4g accordingly.

Since the gesture input 40 stays in the first lighting range control area 12 of each light 4a to 4g, the control unit 6 determines a demanded lighting range of a percentage value of 0% for the lights 4a to 4g.

FIG. 11B shows to which percentage values the lighting ranges of the lights 4a to 4g are set by the control unit 6 in response to the gesture input 40. The lighting ranges of the lights 4a to 4g are set each to a percentage value of 0% according to the demanded lighting ranges for the lights 4a to 4g. So, all lights 4a to 4g are switched off again.

All references cited herein are incorporated herein in their entireties. If there is a conflict between definitions herein and in an incorporated reference, the definition herein shall control.

### LISTING OF DRAWING ELEMENTS

1 vehicle
2 light control system
3 light arrangement
4a light
4b light
4c light
4d light
4e light
4f light
4g light
5 sensory input device
6 control unit
7 controller
8 memory
9 interface
10 sensor area
11a first light control area
11b second light control area
11c third light control area
11d fourth light control area
11e fifth light control area
11f sixth light control area
11g seventh light control area
12 first lighting range control area
13 second lighting range control area
14 third lighting range control area
15 hand
16 gesture input
17 starting point
18 maximum displacement
19 maximum displacement
20 maximum displacement
21 gesture input
22 starting point
23 maximum displacement
24 first indicator
25 maximum displacement
26 gesture input
27 starting point
28 maximum displacement
29 maximum displacement
30 second indicator
31 gesture input
32 starting point
33 maximum displacement
34 gesture input
35 starting point
36 gesture input
37 starting point
38 maximum displacement
39 gesture input
40 starting point
41 gesture input
42 starting point
43 matrix area
44 gesture input
45 starting point
46 switch field
47 switch field
48 switch field
49 switch field
50 key
51 swap key

1. A light control system for an agricultural vehicle, the system comprising:
a light arrangement comprising at least two lights;
a control unit; and
a sensory input device with a sensor area for recognizing a gesture input; the sensor area comprising:
a first light control area assigned to one of the lights for controlling the one light; and
a second light control area assigned to the other light for controlling the other light (4b);
wherein the control unit is configured to control the lights of the light arrangement independently from each other in response to a single gesture input.

2. The light control system of claim 1, wherein the sensor area is a touch sensitive area for recognizing touch gestures.

3. The light control system of claim 1, wherein the control unit is configured to set a lighting range of each light independently from any other light in response to a single gesture input.

4. The light control system of claim 1, wherein:
the sensory input device comprises a first indicator to indicate a maximum lighting range for each of the at least two lights; and
the control unit is configured to determine the maximum lighting range for each of the at least two lights and control the first indicator to indicate the maximum lighting range for each of the at least two lights.

5. The light control system of claim 1, wherein the first indicator is integrated at least partly in the first light control area for indicating the maximum lighting range of the one light and in the second light control area for indicating the maximum lighting range of the other light.

6. (canceled)

7. The light control system of claim 1, wherein the first light control area and the second light control area each comprise a first lighting range control area, second lighting range control area, and a third lighting range control area for controlling the lighting range of the one and the other light.

8. The light control system of claim 7, wherein the control unit is configured to:
adjust the size of the second lighting range control area of the first light control area according to the maximum lighting range of the one light; and
adjust the size of the second lighting range control area of the second light control area according to the maximum lighting range of the other light.

9. (canceled)

10. The light control system of claim 7, wherein the control unit is configured to set a lighting range of a light of the light arrangement to maximum lighting range if a gesture input recognized in the light control area of the assigned light is located in the third lighting range control area of the light control area of the assigned light only.

11. The light control system of claim 7, wherein the control unit is configured to determine whether the gesture input was started in a first, a second or a third lighting range control area.

12. (canceled)

13. The light control system of claim 7, wherein the control unit is configured to:
determine a demanded lighting range of a light according to a gesture input recognized in the second lighting range control area of the assigned light; and
set the lighting range of the light according to the demanded lighting range of the light.

14. The light control system of claim 13, wherein:
at least one of the lights of the light arrangement is a matrix light having two or more light elements; and
the second lighting range control area of the assigned matrix light comprises a separate switch field for each light element of the matrix light.

15. The light control system of claim 13, wherein the light arrangement comprises a non-dimmable light
being switchable in an off state if the demanded lighting range is below a switching threshold; and
being switchable in an on state if the demanded lighting range is above the switching threshold.

16. The light control system of claim 7, wherein the control unit is configured to determine a demanded lighting range of a light according to a maximum displacement of the gesture input in the second lighting range control area of the assigned light started from the first or the third lighting range control area.

17. The light control system of claim 7, wherein the control unit is configured to determine a demanded lighting range of a light according to a median of a displacement of the gesture input in the second lighting range control area of the assigned light if a starting point of the gesture input was detected in the second lighting range control area.

18. The light control system of claim 1, wherein
the sensory input device comprises a second indicator to indicate a current lighting range for each of the one and the other light; and wherein the the control unit (6) is configured to:
determine a lighting range of the one light and a lighting range of the other light; and
control the second indicator to indicate the lighting range of the one light and the lighting range of the other light.

19. The light control system of claim 7, wherein the first, the second, and the third lighting range control areas are arranged in circular shapes.

20. (canceled)

21. The light control system of claim 1, comprising at least one key, wherein the control unit is configured to:
determine a lighting range of the one light and a lighting range of the other light; and
to assign at least one of the lighting ranges of the one and the other light the key.

22. The light control system of claim 1, wherein the control unit is configured to:
determine a number of lights of the light arrangement; and
assign each light to a different light control area.

23. The light control system of claim 22, wherein the control unit is configured to adjust a number of light control areas of the sensor area according to the number of lights of the light arrangement.

24. (canceled)

25. A method of controlling the lighting ranges of at least two lights of a light arrangement by a sensory input device comprising a first light control area with a first, a second, and a third lighting range control area assigned to one of the at least two lights and a second light control area with a first, a second, and a third lighting range control area assigned to the other of the at least two lights, the method comprising:
recognizing gesture input in the second lighting range control area assigned to the one light and recognizing a gesture input in the second lighting range control area assigned to the other light;
determining a demanded lighting range for each of the at least two lights according to a maximum displacement of the gesture input in each of the second lighting range control areas assigned to the at least two lights started from a first or a third lighting range control area; or
determining a demanded lighting range for each of the at least two lights according to a median of a displacement of the gesture input in each of the second lighting range control area assigned to the at least two lights if a starting point of the gesture input was detected in one of the second lighting range control areas.
